(19) United States
(12) Patent Application Publication
(10) Pub. No.: US 2026/0017699 A1
(43) Pub. Date: Jan. 15, 2026

(54) SYSTEMS AND METHODS FOR SECURE AND MONITORED PEER-TO-PEER ITEM EXCHANGE

(71) Applicant: Wells Fargo Bank, N.A., San Francisco, CA (US)

(72) Inventors: Caroline A. Machado, Mountain View, CA (US); Young M. Yang, San Francisco, CA (US); Tiffany N. Twilley, Foster City, CA (US); Robin H. Lo, San Francisco, CA (US); Jessica DeGregoire, San Francisco, CA (US); Michelle W. Chan, San Francisco, CA (US); Chelsea K. McDermott-Leoncio, San Francisco, CA (US)

(21) Appl. No.: 18/770,849

(22) Filed: Jul. 12, 2024

(51) Int. Cl. G06Q 30/0601; G06Q 20/38; G06Q 20/40

(52) U.S. Cl. CPC G06Q 30/0609; G06Q 20/382; G06Q 20/4014

(57) ABSTRACT

Systems, apparatuses, methods, and computer program products are disclosed for enhancing security of a peer-to-peer item exchange. An example method includes receiving a transfer message and generating an exchange transfer record, wherein the exchange transfer record comprises (a) the indication of the item, (b) an authentication status for the buyer, and (c) an authentication status for the seller. The example method further includes authenticating the buyer based on a buyer mobile driver's license (mDL) associated with the buyer and authenticating the seller based on a seller mDL associated with the seller. The example method further includes updating the exchange transfer record based on the authentication status of the buyer and the authentication status of the seller and providing the exchange transfer record.

### BACKGROUND

Peer-to-peer (P2P) exchanges are a convenient way for individuals to settle obligations to other individuals. Current digital tools facilitating P2P exchanges suffer from both real and perceived counterparty risks.

### BRIEF SUMMARY

P2P exchanges offer a convenient way to transfer items between individuals in exchange for a predetermined amount of funds. However, individuals who wish to participate in P2P exchanges must exercise caution due to the ever-present threat of scams. Traditionally, a cash exchange has been used to facilitate P2P exchanges. However, this approach offers no audit trail and presents many inconveniences, including requiring the individuals to carry cash and associated difficulties with finding with the correct denominations for an exchange. Furthermore, these cash-based P2P exchanges have heightened associated risks, such as theft. While current digital tools facilitating P2P exchanges avoid many of the issues associated with cash-based transactions, such tools currently do not authoritatively verify counterparty user identities. This is particularly true for P2P exchanges that occur between strangers or even friends who have not previously engaged with a P2P exchange using the particular digital tool. Furthermore, individual users may use nicknames or other names that may make it difficult for the counterparty to accurately identify them within the digital tool. Oftentimes, this leaves a party unable to verify the identity of the other party, which may make it difficult to proactively detect would-be fraudsters and/or seek recourse if the party was scammed.

P2P exchanges involving digital items may be particularly at risk for scams. While certain digital tools may facilitate the P2P exchange of these digital items, these tools currently do not provide an indication of the authenticity of the items involved in the exchange prior to the transfer. Furthermore, such P2P exchanges are not currently logged or tracked such that users cannot audit their exchanges if an issue were to arise. As such, buyers may incur the cost of the fake or inauthentic item without recourse.

Therefore, it may be beneficial to provide a P2P exchange tool that enhances P2P exchanges between users. For example, a buyer and/or seller may provide a transfer message to the exchange management system, which may cause the exchange management system to generate an exchange transfer record for an upcoming exchange involving one or more items between a buyer and a seller. The exchange transfer record may include an indication of the items to be exchanged, an authentication status for a buyer, and an authentication status for a seller. The buyer may be authenticated based on a buyer mobile driver's license (mDL) and the seller may be authenticated based on a seller mDL. The exchange transfer record may be updated based on the authentication of the buyer and the authentication of the seller and may be provided to the buyer and/or seller. As such, the parties involved in the exchange may use the exchange transfer record to verify the identity of the other party prior to performing the exchange, thereby ensuring a safer and more secure P2P exchange. Furthermore, the exchange transfer record may be stored in an exchange transfer record repository such that the exchange transfer record may act as an audit trail for the P2P exchange and may serve to trace a party should a dispute or issue arise from the exchange.

The exchange management system may authenticate the buyer and seller based on a buyer mDL and a seller mDL, respectively. By using a respective mDL, the identity of the buyer and/or seller may be authenticated with an entity that is legally recognized to issue credentials and identifications. Furthermore, mDLs may provide a safer and more secure alternative to physical driver's licenses because they may be digitally verified and further, are provisioned to a limited and known number of user devices. As such, unlike physical driver's licenses, which may be copied, stolen, or otherwise misused, mDLs offer a much more secure alternative because they are linked to a user device and/or smart mobile wallet. In some embodiments, the seller device and/or the buyer device may provide a seller mDL authentication request and a buyer mDL authentication request, which may be used to authenticate the buyer and the seller, respectively. For example, the buyer device may provide the buyer mDL authentication request in the transfer message and this buyer mDL authentication request may authenticate an associated buyer mDL with a corresponding issuing authority (IA) system. Similarly, the seller device may provide the seller mDL authentication request in the transfer message and the seller mDL may authenticate an associated seller mDL with a corresponding IA system. If the seller mDL is successfully authenticated, the authentication status of the seller in the exchange transfer record may be updated to reflect that identity of the seller has been verified. If the buyer mDL is successfully authenticated, the authentication status of the buyer in the exchange transfer record may be updated to reflect that identity of the buyer has been verified. Alternatively, if the buyer and/or seller fails to be successfully authenticated, the authentication status of the respective user in the exchange transfer record may be updated to reflect that the identity of the user could not be verified. As such, the parties may be made aware of the authentication status of the other party in real-time and may only perform the exchange once the party has been successfully authenticated. Additionally, in some embodiments, if the party that failed authentication attempts another exchange with a different individual, the transfer message may be flagged for potential fraud in real-time, thus conserving computational resources and bandwidth associated with authenticating the buyer and/or seller.

In some embodiments, the exchange management system may generate an item exchange recommendation for the exchange based on the authentication status of the buyer and/or the authentication status of the seller. The item exchange recommendation for the exchange may be indicative of a recommended course of action for either the buyer and/or seller to take with respect to the item exchange. For example, if a party has not yet been successfully authenticated, the item exchange recommendation for the exchange may be indicative to hold off on the exchange until the party has been successfully authenticated. As another example, if both parties have been successfully authenticated, the item exchange recommendation for the exchange may be indicative that it is now safe to perform the exchange. As yet another example, if a party fails to be successfully authenticated, the item exchange recommendation for the exchange may be indicative to not complete the exchange and may flag the party as a potential fraudster. The other party may thus avoid engaging in a P2P exchange that may be a scam.

In some embodiments, the transfer message may be indicative of a request to determine an inferred authenticity category for the item involved in the exchange. The seller may additionally provide one or more historical transactions parameters associated with the item to the exchange management system and these historical transaction parameters may be used to determine an authenticity category for the item. In some embodiments, the exchange management system may use an authenticity category machine learning model to process the one or more historical transaction parameters along with one or more candidate historical transaction parameters from a candidate historical transaction within a seller account to generate a transaction match likelihood score for the candidate historical transaction. The transaction match likelihood score may be indicative of a likelihood or probability that candidate historical transaction corresponds to a transaction during which the seller purchased the item. As such, the transaction match likelihood score may be used as a proxy for a likelihood of whether the seller legitimately possesses the offered item involved in the P2P exchange. In some embodiments, the inferred authenticity category for the item is determined based on the transaction match likelihood score. Additionally, or alternatively, in some embodiments, the one or more historical transaction parameters are used to identify a merchant identifier associated with the historical transaction. The merchant identifier may then be verified to determine whether the corresponding merchant is associated with the item type corresponding to the item. As such, the merchant identifier indicated by the historical transaction parameters may also act as a proxy for the legitimacy of the item involved in the P2P exchange. In some embodiments, the inferred authenticity category for the item is determined based on whether the merchant identifier is successfully verified.

In some embodiments, the exchange management system receives an exchange confirmation message from a buyer and/or seller and may be indicative that the P2P exchange has occurred between the parties. The exchange transfer record may be updated to reflect that the P2P exchange has occurred and may reflect the time and/or date of the exchange. The exchange transfer record may be stored and/or maintained in the exchange transfer record repository. In an instance in which an issue arises from the P2P exchange, the exchange transfer record may be used to trace the involved parties and view the exchange details as agreed upon by both the buyer and seller. As such, in an instance in which an issue arises from the P2P exchange, the exchange transfer record may provide the exchange details, the identity of the parties, and an indication of whether each party was authenticated.

In some embodiments, upon receipt of the exchange confirmation message, the exchange management system may effectuate the transfer of funds from the buyer account to the seller account. The exchange transfer record may further be updated to reflect the transfer of funds. In some embodiments, the exchange management system may intelligently effectuate the transfer of funds from the buyer account to the seller account. The method of transfer may be dependent upon user preferences in a buyer profile, the user preferences in the seller profile, and/or the like. As such, the exchange management system may effectively and efficiently facilitate the transfer of the funds for the P2P exchange from the buyer account to the seller account. Furthermore, the seller may provide the buyer with the item involved in the P2P exchange and may be guaranteed to receive the agreed upon funds.

Accordingly, the present disclosure sets forth systems, methods, and apparatuses that provide for enhanced P2P exchanges. There are many advantages of these, and other embodiments described herein. For example, one advantage provided by embodiments disclosed herein is an improvement to the functioning of the computing infrastructure of an enterprise (e.g., a bank or financial institution), such as by reducing the burden on enterprise computing resources. For instance, by facilitating authentication of both the seller and buyer prior to the P2P exchange using associated mDLs, embodiments described herein significantly reduce the need for subsequent cancellations, returns, and/or other operations associated with when a P2P exchange is made in error, which often require costly manual intervention and are computationally resource intensive. Thus, the system described herein reduces the complexity P2P exchanges by, among other things, automating processes such authenticating a seller based on a seller mDL and a buyer based on a buyer mDL, determining an inferred authenticity category for items involved in the P2P exchange, automatically effectuating the transfer funds from the buyer account to the seller account in an intelligent manner, and storing and maintaining a corresponding exchange transfer record to reflect the P2P exchange for audit purposes.

Another technical advantage of the example systems described herein is an improvement to network security technologies and/or authentication technologies. As explained in greater detail below, example embodiments provide increased security for data, payment accounts, and/or valuable resources (e.g., financial resources) related to users (e.g., buyers and sellers) and/or enterprises by utilizing device-based solutions (e.g., mDLs associated with respective users) for authentication. In this regard, the exchange management system may be employed to remotely authenticate a buyer and/or seller based on a respective mDL. As will be described in greater detail below, utilizing mDLs that have been tied to user devices adds an additional layer of trust to each transaction facilitated by the exchange management system.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for facilitating secure and monitored peer-to-peer item exchange.

FIG. 2 illustrates a schematic block diagram of example circuitry embodying a system device that may perform various operations in accordance with some example embodiments described herein.

FIG. 3 illustrates a schematic block diagram of example circuitry embodying a buyer device or seller device that may perform various operations in accordance with some example embodiments described herein.

FIG. 4 illustrates an example flowchart diagram for generating and maintaining an exchange transfer record for the P2P exchange, in accordance with some example embodiments described herein.

FIG. 5 illustrates an example flowchart diagram for authenticating a buyer based on a buyer mDL authentication request, in accordance with some example embodiments described herein.

FIG. 6 illustrates an example flowchart diagram for authenticating a seller based on a seller mDL authentication request, in accordance with some example embodiments described herein.

FIG. 7 illustrates an example flowchart diagram for determining an inferred authenticity category based on a transaction match likelihood score, in accordance with some example embodiments described herein.

FIG. 8 illustrates an example flowchart diagram for determining an inferred authenticity category based on whether a merchant identifier is successfully verified, in accordance with some example embodiments described herein.

FIG. 9 illustrates an example user interface associated with a P2P exchange tool for performing an P2P exchange, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “user device” or “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server,” “server device,” or “server system” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

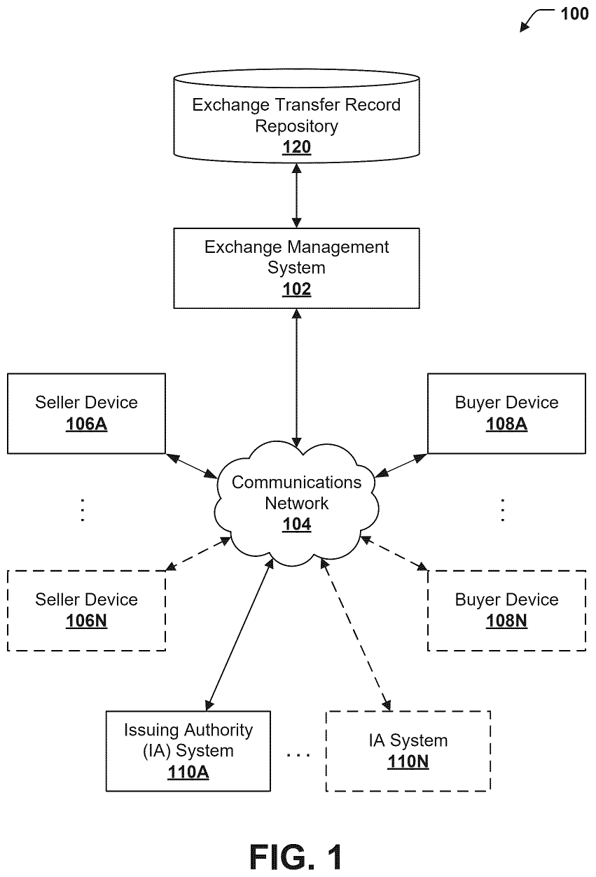

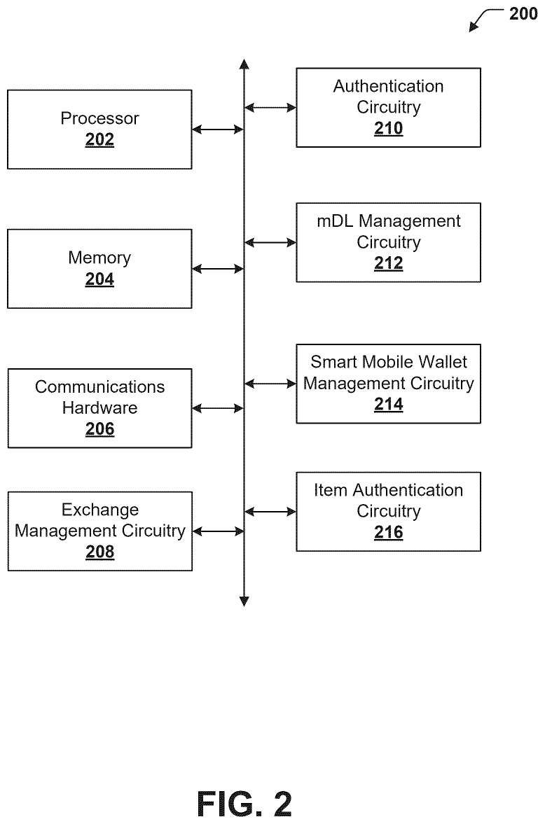

Example embodiments described herein may be implemented using any of a variety of computing devices or servers. To this end, FIG. 1 illustrates an example environment 100 within which various embodiments may operate. As illustrated, an exchange management system 102 may receive and/or transmit information via communications network 104 (e.g., the Internet) with any number of other computing devices and/or computing systems, such as one or more of seller devices 106A-106N, buyer devices 108A-108N, and/or issuing authority (IA) systems 110A-110N. The exchange management system 102 may be implemented as one or more computing devices or servers, which may be composed of a series of components. Particular components of the exchange management system 102 are described in greater detail below with reference to apparatus 200 in connection with FIG. 2.

In various embodiments, the exchange management system 102 may be associated with an enterprise (e.g., a financial institution, bank, and/or the like) and may be configured to manage various smart mobile wallet processes for users associated with said enterprise. For example, the exchange management system 102 may be configured to manage, execute, initiate, and/or otherwise facilitate one or more smart mobile wallet processes, mDL authentication processes, item exchange processes, payment account linking processes, payment account transaction processes, user identity verification process, user authentication processes, and/or the like for a plurality of users associated with the respective enterprise.

In this regard, various users (e.g., a buyer and/or a seller) associated with an enterprise may interact with the exchange management system 102 via a software application instance, where the software application instance may be configured to facilitate one or more of the various smart mobile wallet, mDL authentication processes, and/or item exchange processes described herein. In various embodiments, the software application instance associated with the exchange management system 102 may be installed and/or downloaded to a user device (e.g., seller devices 106A-106N and/or buyer devices 108A-108N, configured as a mobile device, laptop, and/or the like) and may present one or more user interface configurations to a respective user.

As such, the software application instance associated with the exchange management system 102 may be configured to guide a user through the various steps of a secure and monitored item exchange process that may require users (e.g., a buyer and a seller) to be authenticated based on a corresponding mDL. For example, the software application instance associated with the exchange management system 102 may be configured to cause display of various interactive user interface elements to the user that are configured to enable the user to manage one or more portions of smart mobile wallet data (e.g., payment account data, payment card data) and/or user data (e.g., user attribute data, user profile data, user account data, and/or other user data).

In some embodiments, the software application instance may be configured to enable a user to access a smart mobile wallet (e.g., a digital wallet) configured to manage one or more of a user's mDL, payment accounts (e.g., credit accounts, checking accounts, savings accounts, investment accounts), payment cards (e.g., credit cards, debit cards, and/or the like associated with the user's payment accounts), and/or historical transaction records that are associated with a respective enterprise employing the exchange management system 102. Additionally or alternatively, in various embodiments, the software application instance associated with the exchange management system 102 may be configured to enable a user to access a software application framework related to a respective enterprise by, for example, providing (e.g., transmitting, enabling, toggling, configuring, etc.) one or more access permissions for a user device (e.g., any one of seller device 106A-106N and/or buyer device 108A-108N) associated with the user, where the one or more access permissions enable the user device to access the software application framework associated with the enterprise.

In some embodiments, the exchange management system 102 may be configured to facilitate the execution of one or more processes related to an item exchange process for a respective user (e.g., a buyer and/or a seller) based on authenticating an mDL associated with the respective user. As a non-limiting example, the exchange management system 102 may be configured to authenticate a buyer based on a respective buyer mDL associated with the buyer and may reflect whether the buyer has been successfully authenticated in an associated exchange transfer record. In this regard, the exchange management system 102 may be configured to store, integrate with, manage, and/or utilize one or more mDLs (and/or data related to the one or more mDLs (e.g., mDL identifying information, cryptographic key information)) associated with a respective user in order to facilitate the various operations described herein. As used herein, the term “mDL” covers various mobile (e.g., digital) identity credential types associated with a respective user including mobile driver's licenses and mobile identification cards. An mDL may be an electronically managed data structure configured to be accessed, processed, and/or otherwise utilized by the exchange management system 102 for various user authentication processes.

In this regard, an mDL may be configured to store or point to (e.g., programmatically reference) various credential data associated with a respective user (e.g., a buyer and/or seller) including, but not limited to, personally identifiable information (PII) (e.g., given name, family name, name prefix, name suffix, driver's license number, social security number, administrative number), user information (e.g., height, eye color, hair color, age, organ donor status, veteran status, gender information, sex information, race information, ethnicity information, user portrait image data, user signature data), contact information (e.g., residential address information, phone number, email address), credential validity data (e.g., credential issue dates, credential expiration dates, credential revocation status), credential endorsement data (e.g., hazmat endorsement, commercial driver's license (CDL) data, Department of Homeland Security (DHS) compliance data (e.g., “REAL ID” compliance data)), credential restriction data (e.g., driving restrictions, driving conditions, vehicle weight class restrictions), and/or the like associated with the respective user. Additionally, an mDL may be configured to store and/or point to various cryptographic key information (e.g., public key information used to identify the mDL, a corresponding user device, and/or a corresponding user) and/or originating IA data (e.g., cryptographic key information and/or identifying data associated with an originating IA).

An mDL may be issued (e.g., provisioned) to a respective user by an IA system 110A associated with a particular IA. An IA may be an entity that is legally entitled (or otherwise recognized as the relevant authority) to issue credentials, such as driver's licenses and/or other identification cards. An IA system 110A may be a computing system (e.g., a server system) associated with an agency, department, regulatory body, and/or government office entitled to issue legal credentials within a particular jurisdiction such as a respective county, township, state, province, or nation (in some implementations, an IA system may be a private organization authorized to act as the IA for a corresponding physical region). For example, an IA system 110A may be associated with a branch of the Department of Motor Vehicles (DMV) within a particular state in the United States (e.g., North Carolina) that is legally entitled to issue credentials (e.g., mDLs, driver's licenses, state identification cards) to individuals residing in that particular state. In some embodiments, an mDL may be issued in compliance with various national credentialing initiatives (e.g., REAL ID compliance) and/or may be issued under various licensing programs (e.g., the Enhanced Driver's License program (EDL)). Additionally, or alternatively, in some embodiments, an mDL may be administered, managed, employed, and/or otherwise utilized by the exchange management system 102 in compliance with various standards set forth by the American Association of Motor Vehicle Administrators (AAMVA). Additionally, or alternatively, in some embodiments, an mDL may be administered, managed, employed, and/or otherwise utilized by the exchange management system 102 in compliance with various standards set forth by the International Organization for Standardization and the International Electrotechnical Commission (IEC) (e.g., ISO/IEC 18013-5). It will be understood that other standards may apply in some implementations.

An mDL may be a digital version of a physical legal credential (e.g., a driver's license) associated with a user and may comprise and/or be associated with the same data as the legal credential. In some embodiments, an mDL associated with a user (e.g., a buyer and/or seller) may be stored in a storage device (e.g., a server system) of an IA system 110A and one or more portions of credential data related to the mDL may be retrieved in real time, or near-real time, during a transaction associated with the user (e.g., an online transaction requiring user authentication, user age verification, and/or the like). Additionally, or alternatively, once an mDL is issued to a user by a respective IA (e.g., by way of a corresponding IA system 110A), the mDL may be stored locally on a user device associated with the user (e.g., any one of seller devices 106A-106N and/or buyer devices 108A-108N) such that the mDL may be used without relying on a communications network (e.g., communications network 104). Additionally, or alternatively, in some embodiments, an mDL may be stored in a smart mobile wallet associated with the user and managed by the exchange management system 102, and the mDL may be accessed and/or utilized by the user via the smart mobile wallet to execute various mDL-based transactions.

In some examples, an IA may provision an mDL to a particular user device (e.g., u any one of seller device 106A-106N and/or buyer device 108A-108N) associated with a user such that the mDL is associated with various user device identification data related to the particular user device (e.g., cryptographic identification data such as a public key). This may ensure that an mDL associated with a respective user cannot be transferred to multiple devices without authorization by the IA system (e.g., IA system 110A) and used in fraudulent transactions. Furthermore, associating an mDL with a particular user device (e.g., any one of seller device 106A-106N and/or buyer device 108A-108N) also enables the exchange management system 102 and/or an IA system of an IA (e.g., IA system 110A) to verify that the intended user of the mDL is in possession of the mDL. Further still, associating an mDL with a particular user device (e.g., any one of seller device 106A-106N and/or buyer device 108A-108N) also ensures the safe transfer of sensitive credential data to and/or from the intended user of the mDL. In various examples, a user may store multiple copies of an mDL on multiple user devices (e.g., user devices 108A-108N). However, in such examples, each respective copy of the mDL may be cryptographically coupled to a respective user device by the IA system (e.g., IA system 110A) which provisioned the mDL. In this manner, each copy of the mDL can be independently verified against a respective user device to ensure that an mDL, or credential data associated with the mDL, cannot be transferred to unauthorized user devices.

An mDL may be associated with various mDL data security mechanisms used to ensure the validity of the mDL, authenticate an originating IA that issued the mDL, protect a user's personal data, and/or facilitate secure mDL-based transactions. In this regard, an mDL may be associated with a mobile security object (MSO) and/or various public and private cryptographic key information. An MSO is an electronically managed data structure that enables the authentication of the accuracy and origin of various credential data associated with the mDL during mDL-based transactions. In various examples, an MSO is associated with one or more portions of credential data related to the issue date, expiration date, user signature, and/or expected credential update time associated with the mDL. In various embodiments, the one or more portions of credential data associated with the MSO may be used to verify the validity and/or status of the mDL during various transactions. For example, if the credential data associated with the MSO indicates that the mDL is expired, the corresponding user may not be permitted to engage in one or more transactions using the mDL (e.g., one or more age-restricted purchase transactions).

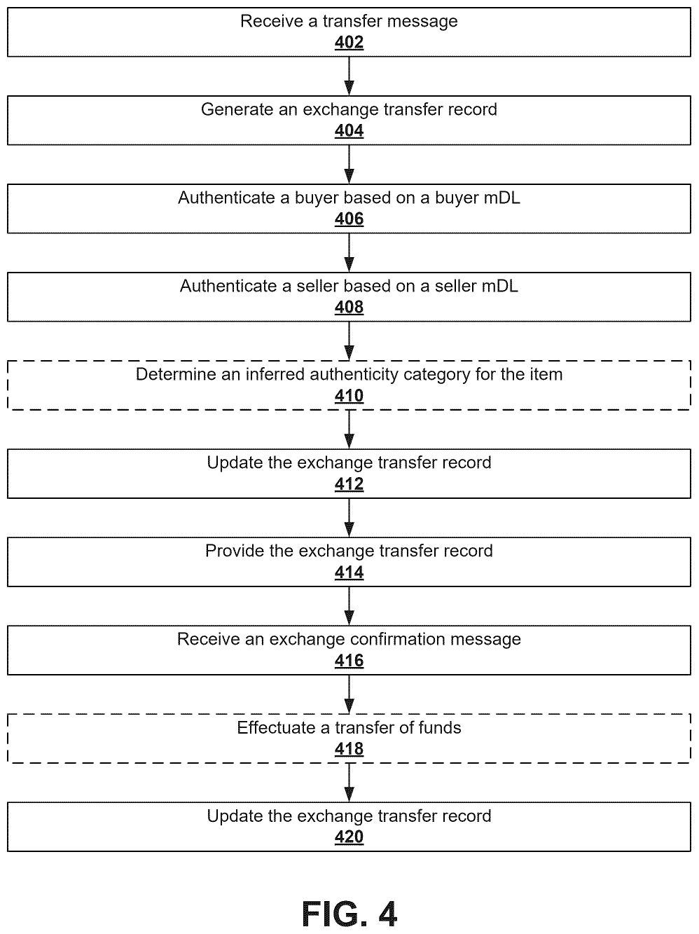

Additionally, an mDL may be associated with various cryptographic key information (e.g., public/private key pair information) that may be utilized by the exchange management system 102 to authenticate an originating IA that issued the mDL, verify one or more portions of credential data associated with an mDL, and/or facilitate various mDL-based transactions (e.g., item exchange operations, retail purchase transactions, user authentication protocols, mDL data queries) for a user associated with the mDL. For example, an IA associated with a respective IA system 110A may be associated with a unique public key that may be utilized by the exchange management system 102 to identify and/or authenticate the originating IA of a respective mDL. As such, in various examples, an mDL may be configured to store and/or point to the public key information associated with the IA from which the mDL was provisioned. Additional details related to the execution of various operations related to one or more mDLs associated with a user by the exchange management system 102 will be described in greater detail herein with reference to FIGS. 4-8.

In some embodiments, the exchange management system 102 further comprises and/or integrates with exchange transfer record repository 120 that comprises a distinct component from other components of the exchange management system 102. Exchange transfer record repository 120 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Additionally, or alternatively, the storage device may host the software executed to operate the exchange management system 102. Additionally, or alternatively, the storage device may store information relied upon during operation of the exchange management system 102, such as the exchange transfer records generated for a particular P2P item exchange. In some embodiments, exchange transfer record repository 120 may further store information, such as various user data (e.g., user attribute data, user identification data), mDL data (e.g., cryptographic information, credential information), enterprise data (e.g., payment account data, user transaction data, product and/or service data), smart mobile wallet data (e.g., payment account data, payment card data, and/or the like associated with a user), distribution data, logistical data, legal data, software application framework data, etc.), and/or the like configured in various data formats to be utilized by the exchange management system 102. In addition, exchange transfer record repository 120 may store control signals, device characteristics, and/or access credentials enabling interaction between the exchange management system 102 and/or one or more of seller devices 106A-106N and/or buyer devices 108A-108N.

In various embodiments, the one or more seller devices 106A-106N and/or the one or more buyer devices 108A-108N may be embodied by any computing devices known in the art. The one or more seller devices 106A-106N and/or the one or more buyer devices 108A-108N need not themselves be independent devices but may be peripheral devices communicatively coupled to other computing devices.

### Example Implementing Apparatuses

The exchange management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 2-8. As illustrated in FIG. 2, the apparatus 200 may include processor 202, memory 204, communications hardware 206, exchange management circuitry 208, authentication circuitry 210, mDL management circuitry 212, and/or smart mobile wallet management circuitry 214, item authentication circuitry 216, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204, the storage device, or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, and/or the like for enabling the apparatus 200 to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, software application instance (e.g., a mobile application), dedicated client device, or the like. In some embodiments, the communications hardware 206 may include a keyboard, a mouse, a touch screen, touch areas, soft keys, a microphone, a camera, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an exchange management circuitry 208 that may be configured to generate, update, and/or maintain an exchange transfer record for a P2P item exchange. The exchange management circuitry 208 may utilize processor 202, memory 204, or any other hardware component included in the apparatus 200 to perform these operations, as described in connection with FIGS. 4-8 below. The exchange management circuitry 208 may further utilize communications hardware 206 to gather data from a variety of sources (e.g., the seller devices 106A-106N, buyer devices 108A-108N, or exchange transfer record repository 120, as shown in FIG. 1), and/or exchange data with a user (e.g., buyer or seller).

In addition, the apparatus 200 further comprises mDL management circuitry 212. In some embodiments, the mDL management circuitry 212 may be configured to facilitate the execution of one or more mDL authentication and/or IA authentication operations for an enterprise associated with the exchange management system 102. Additionally, the mDL management circuitry 212 may utilize processor 202, memory 204, or any other hardware component included in the apparatus 200 to perform these operations, as described in connection with FIGS. 4-8 below. The mDL management circuitry 212 may further utilize the communications hardware 206 to gather data from, or transmit data to, a variety of sources (e.g., the seller devices 106A-106N, buyer devices 108A-108N, the IA systems 110A-110N, and/or any storage devices associated with the exchange management system 102), and/or exchange data with a user. In some embodiments, the mDL management circuitry 212 may work in conjunction with the authentication circuitry 210 and/or the smart mobile wallet management circuitry 214 in order to execute one or more of the methods described herein. For example, in some embodiments, the mDL management circuitry 212 may integrate with and/or otherwise leverage the authentication circuitry 210 to facilitate the authentication of a buyer and/or seller based on a respective mDL associated with the buyer and/or seller.

In various circumstances, an IA system (e.g., IA system 110A) that previously issued an mDL to a respective user may periodically update credential data associated with the mDL (e.g., new user contact information, updated credential restrictions, updated credential endorsements). As such, the mDL management circuitry 212 may be configured to retrieve and/or receive updated credential data associated with a user's mDL from an IA system (e.g., IA system 110A) and facilitate the updating of the user's mDL based on the updated credential data. For example, if an mDL associated with a user is stored in a smart mobile wallet being managed by the exchange management system 102, the mDL management circuitry 212 may be configured to receive updated credential data associated with the user's mDL from the originating IA system (e.g., IA system 110A) and subsequently update the user's mDL in the smart mobile wallet based on the updated credential data.

In some embodiments, the mDL management circuitry 212 may work in conjunction with the smart mobile wallet management circuitry 214 in order to update an mDL stored in a smart mobile wallet stored on a user device (e.g., seller devices 106A-106N and/or buyer devices 108A-108N). In such embodiments, the mDL management circuitry 212 may be configured to query one or more storage devices (e.g., server systems) associated with an IA system (e.g., IA system 110A) in order to retrieve current and/or updated credential data in response to one or more interactions with a user interface associated with the smart mobile wallet. Additionally, or alternatively, the mDL management circuitry 212 may be configured to periodically query to one or more storage devices (e.g., server systems) associated with an IA system (e.g., IA system 110A) based on a predefined schedule (e.g., once a day, once a week, once a month, once every 90 days) in order to retrieve current and/or updated credential data associated with a user' mDL.

In various examples, an IA (e.g., a branch of the DMV) associated with a respective IA system (e.g., IA system 110A) may enforce various mDL data freshness requirements associated with the mDLs the IA system provisions to users. In this regard, an MSO associated with a respective mDL may indicate a technical validity period associated with the mDL (e.g., a 30-day validity period). As such, the mDL management circuitry 212 may utilize the technical validity period indicated by the MSO to ensure that the credential data associated with the mDL stored on a user device (e.g., seller device 106A-106N and/or buyer device 108A-108N) is updated and/or current. For example, if the mDL management circuitry 212 determines that the technical validity period indicated by the MSO has expired, the mDL may be invalidated until the credential data associated with the mDL is refreshed (e.g., updated, verified) by the IA system 110A associated with the IA from which the mDL was issued. In some examples, the technical validity period of the mDL indicated by the MSO may be shorter than a validity period of the mDL and/or the corresponding physical legal credential associated with the mDL (e.g., an expiration date of a driver's license associated with the mDL).

For example, legal credentials (e.g., a driver's license and/or the corresponding mDL) are commonly associated with a relatively long validity period (e.g., five to seven years from the date of issue of the legal credential). However, problems may arise if an IA assigns various credential restrictions (e.g., driving restrictions) and/or credential endorsements (e.g., weighted vehicle endorsements) to a particular user's legal credential, yet the user fails to have the legal credential (e.g., a corresponding physical credential) updated with said credential restrictions and/or credential endorsements. To address such problems, if the mDL management circuitry 212 determines that the technical validity period indicated by the MSO of the mDL has expired, the corresponding mDL may flag the mDL such that the mDL will fail various authentication protocols during an mDL-based transaction.

In this regard, the mDL management circuitry 212 may be configured to facilitate the resetting of the technical validity period indicated by the MSO of the mDL in conjunction with a corresponding IA system (e.g., IA system 110A). Additionally, or alternatively, the mDL management circuitry 212 may be configured to facilitate the updating and/or verification of the credential data associated with an mDL stored on a user device (e.g., seller device 106A-106N and/or buyer device 108A-108N) each time the technical validity period associated with the MSO of the mDL is reset. This mDL data security mechanism ensures that the credential data associated with a user's mDL is always accurate and up to date.

As described herein, an mDL may be associated with various cryptographic key information (e.g., public/private key pair information) that may be utilized by the exchange management system 102 to authenticate an originating IA that issued the mDL, verify one or more portions of credential data associated with an mDL, and/or facilitate various mDL-based operations (e.g., item exchange operations, retail purchase transactions, user authentication protocols, mDL data queries) for a user associated with the mDL. In this regard, the mDL management circuitry 212 may be configured to generate and/or transmit an IA authentication request comprising a public key associated with an IA to a corresponding IA system 110A in order to verify that a particular mDL was indeed provisioned by the IA associated with the IA system 110A.

In some examples, an mDL may only comprise (e.g., store, point to) identifying information related to a particular IA such that the mDL management circuitry 212 may be configured to first obtain a public key associated with the IA from a corresponding IA system 110A based on the identifying information. Once the public key information associated with the IA is obtained, the mDL management circuitry 212 may be configured to generate an IA authentication request comprising the public key of the IA and transmit the IA authentication request to the IA system 110A (e.g., via the communications network 104). As such, the mDL management circuitry 212 may be configured to receive, from an IA system (e.g., IA system 110A) and in response to the IA authentication request, one or more portions of data indicating whether the IA is a bona fide IA and/or whether the mDL indeed originated from the IA.

Once the mDL management circuitry 212 confirms the validity of the IA and/or confirms that a particular mDL associated with a user originated from the IA, the mDL management circuitry 212 may be configured to generate a digital token comprising cryptographic information (e.g., public key information) associated with the mDL and the user. Additionally, in some embodiments, the cryptographic information associated with the mDL and comprised in the digital token may be user device identification data by which a user device (e.g., any one of seller device 106A-106N and/or buyer device 108A-108N) of the respective user may be uniquely identified. In various examples, the mDL management circuitry 212 may generate and/or transmit the digital token to an IA system (e.g., IA system 110A) such that the IA system may decrypt the cryptographic information comprised in the digital token. In this manner, the IA system (e.g., IA system 110A) may authenticate (e.g., verify) one or more portions of credential data associated with the mDL and/or one or more portions of user device identification data associated with the user device (e.g., any one of seller device 106A-106N and/or buyer device 108A-108N). In this regard, the mDL management circuitry 212 may be configured to receive, from the IA system (e.g., IA system 110A) and in response to transmitting the digital token, one or more portions of data indicating whether the mDL and/or the user device (e.g., any one of seller device 106A-106N and/or buyer device 108A-108N) identified by the digital token is valid. Furthermore, in various examples, the mDL management circuitry 212 may be configured to receive, from the IA system (e.g., IA system 110A) and in response to transmitting the digital token, one or more portions of credential data associated with the mDL.

In some embodiments, the mDL management circuitry 212 may be configured to generate a digital token comprising cryptographic information (e.g., public key information) associated with an mDL and/or a user device (e.g., any one of seller device 106A-106N and/or buyer device 108A-108N) associated with a particular user in response to an mDL authentication request associated with the particular user. In some embodiments, the mDL authentication request may be a request to authenticate an mDL associated with the particular user and thereby authenticate the identity of the particular user for one or more mDL-based transactions. A respective mDL authentication request may comprise one or more of cryptographic information (e.g., public key information) associated with an mDL and/or a user device (e.g., any one of seller device 106A-106N and/or buyer device 108A-108N). Additionally, or alternatively, a respective mDL authentication request may comprise one or more desired data elements (e.g., one or more desired portions of credential data) associated with the mDL, location data, user profile data, user account data, social media data, smart mobile wallet identification data, user device identification data, and/or the like associated with the particular user. In various examples, the mDL authentication request may be associated with one or more of a seller or a seller, and may be comprised in, or triggered by, a transfer request received by the exchange management system 102.

In various examples, an mDL validity response received from an IA system (e.g., IA system 110A) based on a digital token generated by the mDL management circuitry 212 may comprise the entirety of the credential data associated with the mDL of the particular user. Additionally, or alternatively, in various other examples, an mDL validity response received from an IA system (e.g., IA system 110A) based on a digital token generated by the mDL management circuitry 212 may comprise a verification of the desired credential data associated with the mDL that was indicated by an mDL authentication request. Additionally, or alternatively, in various other examples, an mDL validity response received from an IA system (e.g., IA system 110A) based on a digital token generated by the mDL management circuitry 212 may comprise a verification of the user device identification data associated with the user device (e.g., any one of seller device 106A-106N and/or buyer device 108A-108N) of the particular user. For example, the mDL validity response may verify that the user device currently associated with the mDL is the same (e.g., intended) user device that the mDL was originally provisioned to. In this manner, the exchange management system 102 may be configured to confirm the validity of the mDL data of an mDL associated with a particular user in order to authenticate the identity of the particular user. Additionally, this enables the exchange management system 102 to confirm whether the intended user and/or user device (e.g., any one of seller device 106A-106N and/or buyer device 108A-108N) associated with the mDL is currently in possession of the mDL. These and other operations associated with the mDL management circuitry 212 will be described in further detail herein below with reference to FIGS. 4-8.

In addition, the apparatus 200 further comprises authentication circuitry 210. In some embodiments, the authentication circuitry 210 may be configured to facilitate the execution of one or more user authentication operations for an enterprise associated with the exchange management system 102. Additionally, the authentication circuitry 210 may utilize processor 202, memory 204, to perform these operations, as described in connection with FIGS. 4-6 below. The authentication circuitry 210 may further utilize the communications hardware 206 to gather data from, or transmit data to, a variety of sources (e.g., any one of seller devices 106A-106N, buyer devices 108A-108N, the IA systems 110A-110N, and/or any storage devices associated with the exchange management system 102), and/or exchange data with a user. In some embodiments, the authentication circuitry 210 may work in conjunction with the mDL management circuitry 212 and/or the smart mobile wallet management circuitry 214 in order to execute one or more of the methods described herein. For example, in some embodiments, the authentication circuitry 210 may integrate with and/or otherwise leverage the mDL management circuitry 212 to facilitate the identification and/or authentication of a buyer and/or seller based on a respective mDL associated with the buyer and/or seller.

Additionally, the authentication circuitry 210 may be configured to identify a smart mobile wallet associated with a respective user (e.g., a buyer, a seller, and/or the like). In various examples, once the authentication circuitry 210 identifies a smart mobile wallet that is associated with the respective user, the authentication circuitry 210 may be configured to generate a user identification data request based on user attribute data associated with the respective user (e.g., the buyer, the seller, and/or the like). The authentication circuitry 210 may be configured to leverage the communications hardware 206 to transmit the user identification data request to the smart mobile wallet ostensibly associated with the respective user. Furthermore, the authentication circuitry 210 may be configured to leverage the communications hardware 206 to receive user identification data from the smart mobile wallet ostensibly associated with the respective user based on the user identification data request.

In various examples, the user identification data associated with a respective user (e.g., the buyer, the seller, and/or the like) comprises cryptographic information associated with one or more of an mDL and/or a user device (e.g., any one of seller device 106A-106N and/or buyer device 108A-108N) associated with the respective user. In some embodiments the cryptographic information associated with the mDL and/or the user device may be a public key of a public/private key pair, where the public key is provisioned to the respective user by an IA upon issuance of the mDL. Such cryptographic information may be utilized by the exchange management system 102 and/or an IA system (e.g., IA system 110A) associated with the IA that provisioned the mDL to identify and/or authenticate the mDL, one or more portions of desired mDL credential data, and/or the user device associated with the respective user. In this regard, the authentication circuitry 210 may be configured to verify that the smart wallet ostensibly associated with the respective user (e.g., the seller, the buyer, and/or the like) is indeed associated with the respective user and that the smart mobile wallet management circuitry 214 may safely transmit and/or receive data (e.g., item exchange data, payment account data, transaction data) to and/or from the smart mobile wallet associated with the respective user.

In addition, the apparatus 200 further comprises smart mobile wallet management circuitry 214. In some embodiments, the smart mobile wallet management circuitry 214 may be configured to facilitate the execution of one or more smart mobile wallet operations and/or transactions for an enterprise associated with the exchange management system 102. Additionally, the smart mobile wallet management circuitry 214 may utilize processor 202, memory 204, to perform these operations, as described in connection with FIGS. 4-8 below. The smart mobile wallet management circuitry 214 may further utilize the communications hardware 206 to gather data from, or transmit data to, a variety of sources (e.g., the seller devices 106A-106N, the buyer devices 108A-108N, the IA systems 110A-110N, and/or any storage devices associated with the exchange management system 102), and/or exchange data with a user. In some embodiments, the smart mobile wallet management circuitry 214 may work in conjunction with the mDL management circuitry 212 and/or the authentication circuitry 210 in order to execute one or more of the methods described herein.

For example, in some embodiments, the smart mobile wallet management circuitry 214 may integrate with and/or otherwise leverage the authentication circuitry 210 to facilitate the identification and/or authentication of a buyer and/or a seller in order to generate and/or provide an exchange transfer record. In various embodiments, the smart mobile wallet management circuitry 214 may be configured to generate an exchange transfer record in response to a transfer message received from a user device (e.g., any one of seller device 106A-106N and/or buyer device 108A-108N). In some embodiments, the transfer message generation request may be generated and/or received from the user device (e.g., any one of seller device 106A-106N and/or buyer device 108A-108N) based on a user interaction with a user interface corresponding to a smart mobile wallet being managed by the exchange management system 102. Furthermore, the transfer request may comprise one or more of an indication of an item to be exchanged, a buyer identifier, a seller identifier, and/or one or more historical transaction parameters associated with the item configured (e.g., indicated, selected, and/or the like) via the interaction with the user interface corresponding to the smart mobile wallet.

In this regard, the smart mobile wallet management circuitry 214 may be configured to leverage the processor 202, the memory 204, and/or the communications hardware 206 to generate, cause transmission of, and/or cause display of a plurality of interactive user interface elements on a user interface associated with a software application instance associated with the exchange management system 102 on a user device (any one of seller device 106A-106N and/or buyer device 108A-108N). The plurality of interactive user interface elements may be configured as one or more interactive text fields, buttons, selectable images, hyperlinks, radio buttons, sliders, embedded multimedia modules, charts, graphs, prompts, notifications, banners, instructions, and/or the like configured to initiate execution of one or more commands (e.g., executable software instructions) based on an interaction (e.g., user input) with the plurality of interactive user interface elements.

Additionally, or alternatively, the smart mobile wallet management circuitry 214 may be configured to leverage the processor 202, the memory 204, and/or the communications hardware 206 to generate and/or configure (e.g., instantiate, update) a smart mobile wallet comprising one or more of a plurality of interactive user interface elements. The smart mobile wallet management circuitry 214 may generate a smart mobile wallet for a respective user (e.g., a buyer, a seller, and/or the like) based on one or more user attributes associated with the respective user and/or enterprise data corresponding to the respective user stored by the enterprise associated with the exchange management system 102. Additionally, the smart mobile wallet management circuitry 214 may be configured to leverage the processor 202, the memory 204, and/or the communications hardware 206 to provide the smart mobile wallet to a user device (e.g., any one of seller device 106A-106N and/or buyer device 108A-108N) associated with the respective user such that the respective user is enabled to interact with and/or utilize the smart mobile wallet to execute various operations, transactions, and/or the like.

Additionally, based on one or more interactions with a respective smart mobile wallet, the smart mobile wallet management circuitry 214 may be configured to facilitate one or more financial transactions for a respective user (e.g., a buyer, a seller, and/or the like). The one or more financial transactions may involve the settlement of a payment (e.g., the withdrawal and transfer of funds) initiated by a respective user (e.g., a buyer) with another user (e.g., a seller). In this regard, the smart mobile wallet management circuitry 214 may be configured to utilize account data (e.g., user account identifier information, user account routing information, and/or the like) associated with one or more means of payment (e.g., a payment card) stored in and/or associated with a smart mobile wallet of a respective user to ensure an appropriate amount of funds is transferred from the respective buyer to the seller. These and other operations associated with the smart mobile wallet management circuitry 214 will be described in further detail herein below with reference to FIGS. 4-8.

In addition, the apparatus 200 further comprises an item authentication circuitry 216 that may be configured to determine an inferred authenticity category for an item involved in the P2P exchange. In some embodiments, the item authentication circuitry 216 may be configured to identify a candidate historical transaction within an associated seller account, generate a transaction match likelihood score, and determine the inferred authenticity category based on the transaction match likelihood score. In some embodiments, the item authentication circuitry 216 may be configured to verify whether a merchant identifier is associated with an item type corresponding to the item and determine the inferred authenticity category is generated based on whether the merchant identifier is successfully verified. The item authentication circuitry 216 may utilize processor 202, memory 204, or any other hardware component included in the apparatus 200 to perform these operations, as described in connection with FIGS. 4-8 below. The item authentication circuitry 216 may further utilize communications hardware 206 to gather data from a variety of sources (e.g., any one of seller devices 106A-106N, buyer devices 108A-108N, and/or exchange transfer record repository 120, as shown in FIG. 1).

Although components 202-216 are described in part using functional language, it will be understood that the particular implementations necessarily include the use of particular hardware. It should also be understood that certain of these components 202-216 may include similar or common hardware. For example, the exchange management circuitry 208, authentication circuitry 210, mDL management circuitry 212, smart mobile wallet management circuitry 214, and/or item authentication circuitry 216, may each at times leverage use of the processor 202, memory 204, and/or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may, in addition, refer to software instructions that configure the hardware components of the apparatus 200 to perform the various functions described herein.

Although the exchange management circuitry 208, authentication circuitry 210, mDL management circuitry 212, smart mobile wallet management circuitry 214, and/or item authentication circuitry 216, may leverage processor 202, memory 204, and/or communications hardware 206 as described above, it will be understood that any of the exchange management circuitry 208, authentication circuitry 210, mDL management circuitry 212, smart mobile wallet management circuitry 214, and/or item authentication circuitry 216, may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the exchange management circuitry 208, authentication circuitry 210, mDL management circuitry 212, smart mobile wallet management circuitry 214, and/or item authentication circuitry 216, comprise particular machinery designed for performing the functions described herein in connection with such elements of apparatus 200.

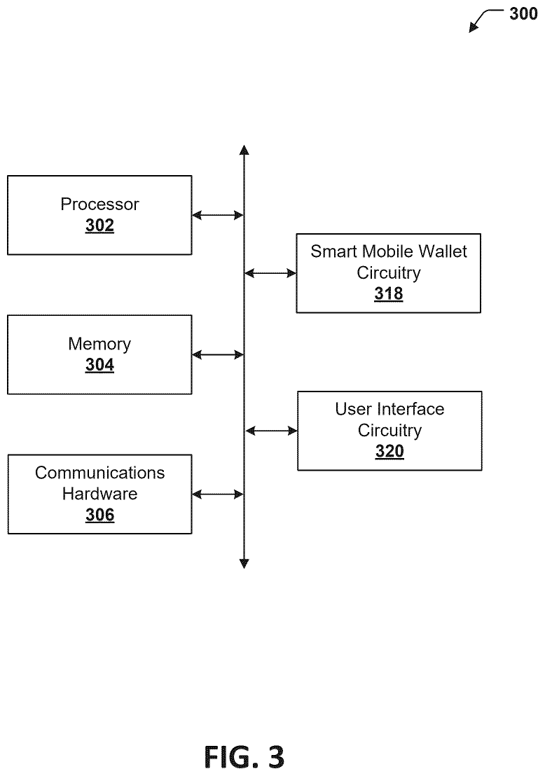

As illustrated in FIG. 3, an apparatus 300 is shown that represents an example seller device (e.g., any of seller devices 106A-106N) or an example buyer device (e.g., any of buyer devices 108A-108N). The apparatus 300 includes processor 302, memory 304, and communications hardware 306, each of which is configured to be similar to the similarly named components described above in connection with FIG. 2. Additionally, the apparatus 300 may also include smart mobile wallet circuitry 318, and/or user interface circuitry 320, each of which may be configured to facilitate the execution of the various methods described herein. For example, the smart mobile wallet circuitry 318, and/or the user interface circuitry 320 may be configured to work in conjunction to facilitate user interaction with the exchange management system 102. Furthermore, the smart mobile wallet circuitry 318 may be configured to manage and/or facilitate one or more actions related to a smart mobile wallet associated with a respective user (e.g., a buyer, a seller, and/or the like) on a user device (e.g., any one of seller devices 106A-106N and/or buyer devices 108A-108N) that has been provisioned by the exchange management system 102. In some embodiments, the smart mobile wallet circuitry 318 may utilize processor 302, memory 304, or any other hardware component included in the apparatus 300 to perform one or more of the operations described in connection with FIGS. 4-8 below.

In some embodiments, the communications hardware 306 may use near-field communication (NFC) to interact with one another device (e.g., a different buyer device or seller device) and/or provide a corresponding mDL authentication request to the other device. For example, apparatus 300 may be the seller device 106A and may have initiated the transfer message. The seller device 106A and buyer device 108A may be physically tapped together to cause the transfer of a buyer mDL authentication request to the seller device 106A, which will provide the buyer mDL authentication request in a transfer message. The communications hardware 306 may detect that the other device is within a predefined threshold of another device emitting NFC signals and an accelerometer of the apparatus 300 may detect that apparatus 300 has been tapped at a time coextensive with the close proximity to the other device. Upon detection of these events occurring, the communications hardware 306 may receive the buyer mDL authentication request. As another example, apparatus 300 may be the buyer device 108A and the seller device 106A may still have initiated the transfer message. Upon detection of the proximate NFC signals and accelerometer measurements, the communications hardware 306 may broadcast the buyer mDL authentication request.

In some embodiments, the smart mobile wallet circuitry 318 includes hardware components designed for generating one or more requests configured to initiate various operations to be executed by the exchange management system 102. For example, the smart mobile wallet circuitry 318 may be configured to generate transfer message for either a buyer or a seller based on one or more interactions (e.g., user input, user selection) with a smart mobile wallet on a user device (e.g., any one of seller devices 106A-106N and/or buyer devices 108A-108N).

In various embodiments, the smart mobile wallet circuitry 318 may be configured to generate responses to various queries transmitted to a smart mobile wallet on a respective user device (e.g., any one of seller devices 106A-106N and/or buyer devices 108A-108N). For example, as described herein, the exchange management system 102 may be configured to generate and/or transmit user identification data requests (e.g., buyer identification data requests, seller identification requests, and/or the like) to respective smart mobile wallets to facilitate the one or more operations described herein. As such, the smart mobile wallet circuitry 318 may be configured to generate and/or cause transmission of a response providing user identification data comprised in and/or associated with a smart mobile wallet on the user device (e.g., any one of seller devices 106A-106N and/or buyer devices 108A-108N).

As described herein, the user identification data associated with a respective user (e.g., the buyer, the seller, and/or the like) may comprise cryptographic information associated with one or more of an mDL and/or a user device (e.g., any one of seller devices 106A-106N and/or buyer devices 108A-108N) associated with the respective user. In some embodiments the cryptographic information associated with the mDL and/or the user device may be a public key of a public/private key pair, where the public key is provisioned to the respective user by an IA upon issuance of the mDL. Such cryptographic information may be utilized by the exchange management system 102 and/or an IA system (e.g., IA system 110A) associated with the IA that provisioned the mDL to identify and/or authenticate the mDL, one or more portions of desired mDL credential data, and/or the user device associated with the respective user.

Additionally, the smart mobile wallet circuitry 318 may be configured to facilitate various actions associated with one or more payment methods associated with a smart mobile wallet on a respective user device (e.g., any one of seller devices 106A-106N and/or buyer devices 108A-108N). For example, the smart mobile wallet circuitry 318 may be configured to facilitate the management of, utilization of, and/or interaction with one or more of a payment card (e.g., a credit card, debit card), payment account (e.g., checking account, saving account), and/or user account affiliated with an enterprise (e.g., financial institution) associated with the exchange management system 102. For instance, in some embodiments, the smart mobile wallet circuitry 318 may be configured to enable a user to check an account balance, view historical transactions, initiate a payment transaction, stop a payment transaction, transfer funds, link a payment account or method, unlink a payment account or method, settle a payment transaction at a point of sale (POS) associated with a merchant, settle an online payment transaction, and/or the like via the smart mobile wallet on a respective user device (e.g., any one of seller devices 106A-106N and/or buyer devices 108A-108N).

Furthermore, the smart mobile wallet circuitry 318 may be configured to facilitate various actions associated with an mDL of a respective user that is stored in and/or associated with the smart mobile wallet on a respective user device (e.g., any one of seller devices 106A-106N and/or buyer devices 108A-108N). For example, the smart mobile wallet circuitry 318 may be configured to cause an mDL to be updated, verified, authenticated and/or deleted from the smart mobile wallet. In some embodiments, the smart mobile wallet circuitry 318 may be configured to leverage the communications hardware 306 to communicate with an IA system (e.g., IA system 110A) in order to retrieve and/or receive one or more portions of mDL data (e.g., updated credential data) associated with an mDL stored in the smart mobile wallet. Additionally, or alternatively, the smart mobile wallet circuitry 318 may be configured to leverage the communications hardware 306 to cause one or more components of the apparatus 200 (e.g., the mDL management circuitry 212) to facilitate the update of an mDL stored in a smart mobile wallet of a respective user device (e.g., any one of seller devices 106A-106N and/or buyer devices 108A-108N).

In addition, the apparatus 300 may also include the user interface circuitry 320, which includes hardware components designed for receiving user inputs and/or rendering virtual graphics outputs. The user interface circuitry 320 may utilize processor 302, memory 304, or any other hardware component included in, or integrated with, the apparatus 300 to perform these operations, as described in connection with FIGS. 4-8 below. The user interface circuitry 320 may further utilize communications hardware 306 to transmit data representative of a user input and/or receive data to render as a virtual graphics output or may otherwise utilize processor 302 and/or memory 304 to generate data representative of a user input and/or generate virtual graphics output, e.g., from based on received data. The user interface circuitry 320 may comprise one or more of a keyboard, pointing device, touchscreen, microphone with speech recognition interface, one or more cameras, and/or one or more other input devices capable of receiving various different user inputs. In addition, the user interface circuitry 320 may comprise a display device including one or more of a screen with graphical user interface (GUI), speaker, light-emitting diode (LED) display, organic LED (OLED) display, LCD display, touchscreen, haptic technology device, and/or other output device capable of rendering information to a user.

Additionally, the user interface circuitry 320 may utilize processor 302, memory 304, smart mobile wallet circuitry 318, or any other hardware component included in, or integrated with, the apparatus 300 to run, host, configure, and/or otherwise execute one or more operations, instructions, and/or commands related to a software application instance and/or smart mobile wallet associated with the exchange management system 102. For example, the user interface circuitry 320 may be configured allow a user to interact with the exchange management system 102 via the software application instance in order to facilitate one or more P2P item exchanges, smart mobile wallet operations, user authentication operations, and/or any of the other methods described herein.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200, or 300, may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of flowcharts.

### Example Operations

Turning to FIGS. 4-8, example flowcharts are illustrated that contain example operations implemented by example embodiments described herein. The operations illustrated in FIGS. 4-8 may, for example, be performed by a system device (e.g., server, etc.) of the exchange management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, exchange management circuitry 208, authentication circuitry 210, mDL management circuitry 212, smart mobile wallet management circuitry 214, item authentication circuitry 216, and/or any combination thereof. It will be understood that user interaction with the exchange management system 102 may occur directly via communications hardware 206, or may instead be facilitated by a separate computing device (e.g., any of seller devices 106A-106N, and/or buyer devices 108A-108N shown in FIG. 1, which may in turn be embodied by an apparatus 300, which is shown and described in connection with FIG. 3), and which may have similar or equivalent physical componentry facilitating such user interaction.

Turning first to FIG. 4, the flowchart illustrates example operations for providing a secure and monitored P2P item exchange between a buyer and seller.

As shown by operation 402, the apparatus 200 may include means, such as processor 202, memory 204, communications hardware 206, and/or the like for receiving a transfer message. An item exchange may involve a seller transferring one or more items to a buyer in exchange for a predetermined amount of funds. An item may be any physical or digital product, resource, merchandise or the like that belongs to the seller, either wholly or in part. For example, an exchange may involve two digital concert tickets and each concert ticket may have a selling price of $100, for a total of $200. Prior to performing the item exchange, during which the seller may transfer the one or more items to the buyer and the buyer may provide the seller with the predetermined fund amount, either the buyer or the seller may provide a transfer message to communications hardware 206. The transfer message may be indicative of an upcoming item exchange between a buyer and a seller and may further be indicative for apparatus to generate and provide an exchange transfer record for the item exchange.

The transfer message may include an indication of one or more items to be exchanged. In some embodiments, an indication of the item may be a description, such as text description, as input by either the buyer and/or seller. In some embodiments, the description may describe the product name. In some embodiments, the indication of the item as provided by the buyer and/or seller may include a form of media, such as an image of the one or more items. In some embodiments, the indication of the one or more items may further include a quantity of an item in an instance in which the one or more items are the same item type and/or are otherwise indistinguishable from one another. In an instance in which the one or more items are different item types and/or are otherwise distinguishable from one another, an indication may be provided for each item.

In some embodiments, the indication of item may be an item identifier. An item identifier may uniquely identify the item from one or more other items and in some embodiments, may be known to a particular merchant that provided the item. For example, an item identifier may be an item number, a serial number, an item code, a stock keeping unit, a universal product code, and/or the like. By way of continuing example, an indication for a first digital concert ticket may be associated with a first serial number and a second digital concert ticket may be associated with a second serial number, different than the first serial number. The serial numbers may be known to an associated merchant.

In some embodiments, the transfer message may further be indicative to authenticate a buyer and a seller for the item exchange. As such, the identity of the buyer and/or seller may be verified for the other party, such that the exchange can be performed more securely. Furthermore, by verifying the identity of the buyer and/or seller, this simplifies the process of dispute handling if needed. In order to authenticate the buyer and/or seller, the transfer message may further include an indication of a buyer and an indication of a seller.

In some embodiments, the indication of the buyer may be a buyer identifier. The buyer identifier may be a unique combination of numbers, letters, and/or characters that uniquely identify the buyer from other users. In some embodiments, the buyer identifier is associated with a buyer's user profile. A user profile may be associated with one or more buyer accounts and may further include user data, user device data (e.g., buyer device identifiers), user preferences (e.g., payment preferences, communication preferences, transfer preferences), and/or the like for the buyer. In some embodiments, the indication of the seller may be a seller identifier. Similarly, the seller identifier may be a unique combination of numbers, letters, and/or characters that uniquely identify the seller from other users. In some embodiments, the seller identifier is associated with a seller's user profile that may be associated with one or more seller accounts and may further include user data, user device data (e.g., seller device identifiers), user preferences (e.g., payment preferences, communication preferences, transfer preferences), and/or the like for the seller. In some embodiments, a seller account and/or buyer account may be associated with a payment account (e.g., credit account, checking account, savings account, investment account). In some embodiments, the seller and/or buyer may not have an associated user profile and/or account associated with apparatus 200.

In some embodiments, the indication of the buyer may be a device identifier of the buyer device (e.g., buyer device 108A) and/or the indication of the seller may be a device identifier of the seller device (e.g., seller device 106A). A device identifier may be a unique combination of numbers, letters, and/or characters that uniquely identify the device. For example, a device identifier may be a phone number, an international mobile equipment identity (IMEI), a serial number, a serial number, and/or the like.

In some embodiments, the indication of the buyer may be a buyer mDL authentication request. A buyer mDL authentication request may include one or more of cryptographic information (e.g., public key information) associated with a buyer mDL and/or a buyer device. Additionally, or alternatively, a buyer mDL authentication request may include one or more desired data elements (e.g., one or more desired portions of credential data) associated with the buyer mDL, location data, user profile data, user account data, social media data, smart mobile wallet identification data, user device identification data, and/or the like associated with the particular buyer. In some embodiments, the buyer mDL authentication request may further include the device identifier for the buyer device which provided the buyer mDL authentication request.

In some embodiments, the indication of the seller may be a seller mDL authentication request. A seller mDL authentication request may include one or more of cryptographic information (e.g., public key information) associated with a seller mDL and/or a seller device. Additionally, or alternatively, a seller mDL authentication request may include one or more desired data elements (e.g., one or more desired portions of credential data) associated with the seller mDL, location data, user profile data, user account data, social media data, smart mobile wallet identification data, user device identification data, and/or the like associated with the particular seller. In some embodiments, the buyer mDL authentication request may further include the device identifier for the seller device which provided the seller mDL authentication request.

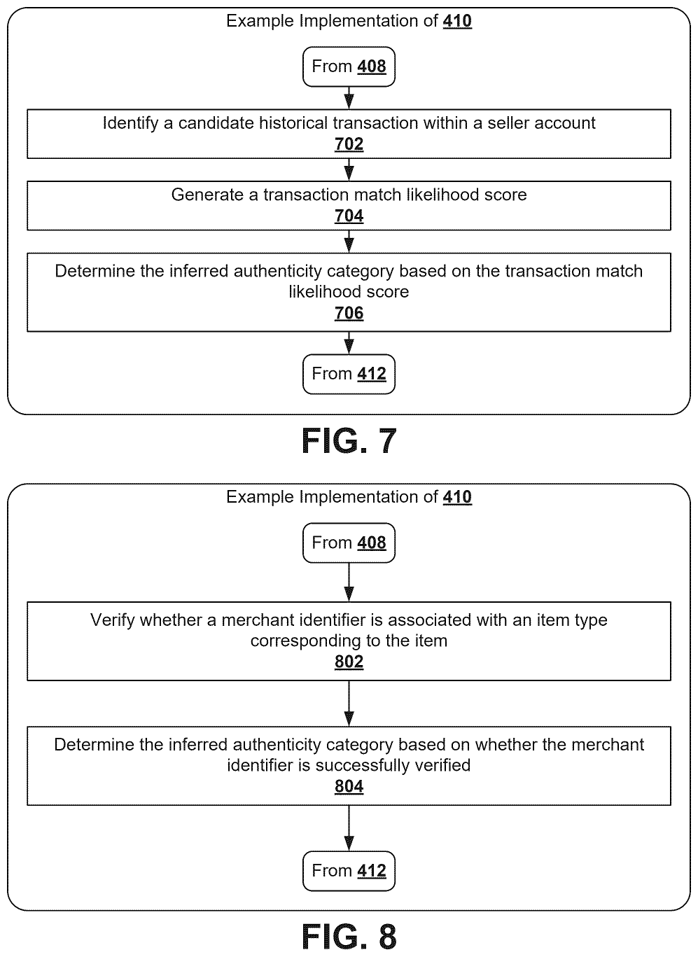

In some embodiments, the transfer message may further include one or more historical transaction parameters associated with the one or more items for the item exchange. These historical transaction parameters may be indicative of an original transaction price for the one or more items, a merchant identifier, a transaction number, a transaction date, a seller account used for the transaction, and/or the like. In some embodiments, the one or more items involved in the item exchange may have been previously purchased by the seller. A seller account may include a candidate historical transaction that may be associated with one or more candidate historical transaction parameters, which may match the one or more provided historical transaction parameters. As such, as discussed in further detail in FIGS. 7-8, in some embodiments, apparatus 200 may be configured to use the determine an inferred authenticity category based on a comparison between the one or more provided historical transaction parameters and the one or more candidate historical transaction parameters.

In some embodiments, the transfer message may further include a current location of the buyer device and/or seller device. For example, the transfer message may include geographic coordinates indicative of the current location of the buyer device (e.g., buyer device 108A) and seller device (e.g., seller device 106A) or may include a relative location of the devices with respect to a reference object.

In some embodiments, the communications hardware 206 may receive the transfer message from the seller device (e.g., seller device 106A). Additionally, or alternatively, the communications hardware 206 may receive the transfer message from the buyer device (e.g., buyer device 108A). The transfer message may be received via a software application. In some embodiments, regardless of the device which provides the transfer message to the communications hardware 206, the transfer message may be generated based on input from both the seller device (e.g., seller device 106A) and the buyer device (e.g., buyer device 108A). In some embodiments, the transfer message may be received by communications hardware 206 in an instance in which both the buyer device (e.g., buyer device 108A) and seller device (e.g., seller device 106A) have received user input indicative that the corresponding user has approved and/or authorized the values for fields in the transfer message. In some embodiments, the buyer and seller may be within a close proximity of one another and may use NFC to interact with one another and/or provide a corresponding mDL authentication requests to the other device and/or exchange information.

In some embodiments, the exchange management circuitry 208 may assign the transfer message a transfer message identifier. The transfer message identifier may uniquely identify the transfer message from other transfer messages or communications. In some embodiments, the communications hardware 206 may be configured to a provide the seller device (e.g., seller device 106A) and buyer device (e.g., buyer device 108A) with the transfer message identifier. The seller device (e.g., seller device 106A) and/or buyer device (e.g., buyer device 108A) may include the transfer message identifier is future communications pertaining to the P2P exchange described by the transfer message and as such, apparatus 200 may be configured to determine these communications are related to the transfer message.

As shown by operation 404, the apparatus 200 may include means, such as processor 202, memory 204, communications hardware 206, exchange management circuitry 208, and/or the like for generating an exchange transfer record. Once the communications hardware 206 receives the transfer message, the exchange management circuitry 208 may generate an exchange transfer record for the item exchange indicated by the transfer message. The exchange transfer record may be generated to include one or more values for various data fields. For example, the exchange transfer record may include data fields for an item name or description for each item, a transaction amount, a note, a buyer authentication status, a seller authentication status, an item exchange recommendation, an inferred authenticity category for each item, an exchange confirmation status, an exchange confirmation date, an exchange confirmation location, and/or the like. As such, the exchange transfer record may exchange transfer record may be indicative of the details of the item exchange as agreed upon by both the buyer and seller. In some embodiments, the exchange transfer record may further include the transfer message identifier.

The one or more values in the exchange transfer record may provide a real-time, up-to-date status of various elements of the item exchange, including user authentication status for the buyer and seller, item authentication status, and an indication of whether the exchange has been performed. A value for a buyer authentication status may describe a current, up-to-date authentication status for the buyer based on whether the buyer has been successfully authenticated. A value for a seller authentication status may describe a current, up-to-date authentication status for the seller based on whether the seller has been successfully authenticated. A value for an item exchange recommendation may describe a recommendation for the buyer and/or seller pertaining to whether the item exchange should occur. A value for an inferred authenticity category may describe a current status of and/or category for an inferred authenticity category determined for a particular item. A value for an exchange confirmation status may be indicative of whether the items have been transferred from the seller to the buyer and/or whether the funds have been transferred from the buyer to the seller. A value for an exchange confirmation date may be indicative of a day, time, and/or other temporal information related to a confirmation of the item exchange and/or fund transfer. A value for an exchange confirmation location may be indicative of location and/or other geographic information related to confirmation of the item exchange and/or fund transfer.

In some embodiments, the exchange management circuitry 208 may determine one or more of the values for the data fields of the exchange transfer record based on the transfer message. For example, the exchange management circuitry 208 may identify values for the item name or description, transaction amount, note, and/or the like for the exchange transfer record directly from the transfer message. For example, the transfer message may include values for corresponding data fields such that the exchange management circuitry 208 may identify these values and populate corresponding data fields within the exchange transfer record accordingly.

In some embodiments, the exchange management circuitry 208 may be configured to determine a default value for one or more data fields within the exchange transfer record. For example, the exchange management circuitry 208 may be required to determine a default value of “pending” or “not started” for a buyer authentication status and seller authentication status. These default values may be updated once a corresponding operation is performed and/or completed. By way of continuing example, the exchange management circuitry 208 may update the buyer authentication status once authentication circuitry 210 determines whether the buyer is successfully authenticated, as described in further detail in operation 406. As another example, the exchange management circuitry 208 may update the seller authentication status once authentication circuitry 210 determines whether the seller is successfully authenticated, as described in further detail in operation 408. As another example, the exchange management circuitry 208 may determine a default value for an inferred authenticity category for an item in an instance in which this service is requested. For example, a default value for the inferred authenticity category may be “pending.” As another example, in an instance in which the seller has not yet provided the one or more historical transaction parameters, the default value for the inferred authenticity category may be “waiting for seller information.” In some embodiments, the exchange management circuitry 208 may determine a default value for an exchange confirmation status. For example, the exchange management circuitry 208 may determine a default value of “not received” for the confirmation status.

The exchange management circuitry 208 may leave one or more values for one or more data fields as blank or otherwise undefined. For example, the exchange management circuitry 208 may leave values for an exchange confirmation date and an exchange confirmation location as blanks because conditions required for these data fields have not yet been met. The exchange management circuitry 208 may first require receipt of an exchange confirmation message prior to populating values for an exchange confirmation date and an exchange confirmation location.

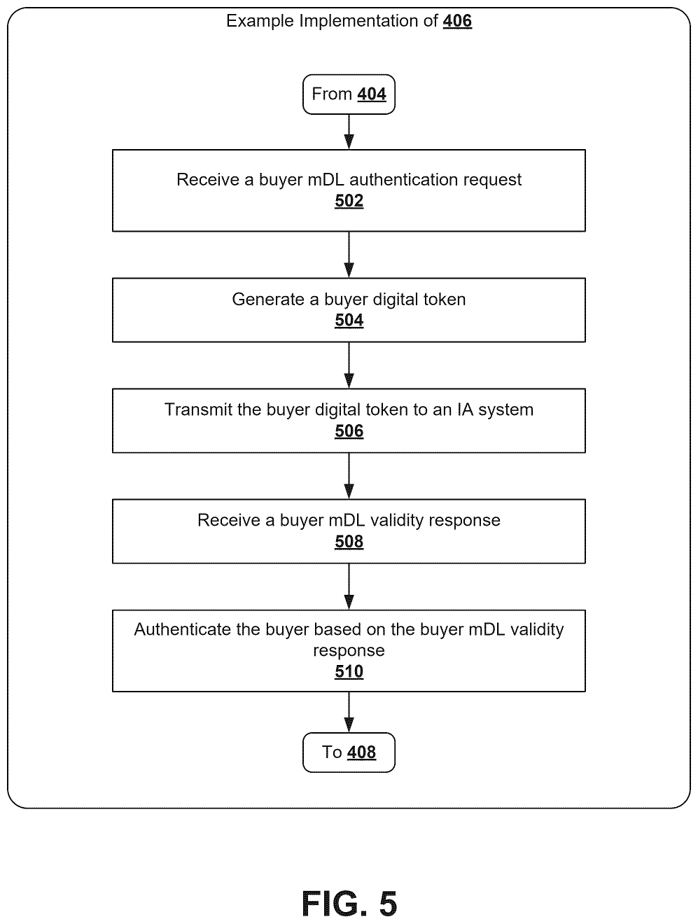

As shown by operation 406, the apparatus 200 may include means, such as processor 202, memory 204, communications hardware 206, authentication circuitry 210, mDL management circuitry 212, smart mobile wallet management circuitry 214, and/or the like for authenticating a buyer based on a buyer mDL. As described above, in some embodiments, the communications hardware 206 may be configured to receive a buyer mDL authentication request. In some embodiments, the buyer mDL authentication request may be received from a buyer device (e.g., buyer device 108A). In some embodiments, the buyer mDL authentication request is included in the transfer message. Alternatively, in some embodiments, buyer mDL authentication request is received in a separate communication from the transfer message. If the buyer mDL authentication request is received in a separate communication, the buyer mDL authentication request may include a transfer message identifier. As such, the authentication circuitry 210 may be configured to identify the corresponding transfer request to which the buyer mDL authentication request pertains. In some embodiments, the authentication circuitry 210 may successfully authenticate the buyer in an instance in which the buyer is successfully verified based on a buyer mDL validity response, as described in FIG. 5

In some embodiments, operation 406 may be performed in accordance with the operations described by FIG. 5. Turning now to FIG. 5, example operations are shown for authenticating a buyer based on a buyer mDL authentication request.

As shown by operation 502, the apparatus 200 may include means, such as processor 202, memory 204, communications hardware 206, and/or the like for receiving a buyer mDL authentication request. The buyer mDL authentication request may be a request to authenticate a buyer mDL associated with the buyer and thereby authenticate the identity of the buyer for the P2P exchange. As described above, the buyer mDL authentication request may include one or more of cryptographic information (e.g., public key information) associated with a buyer mDL and/or a buyer device (e.g., buyer device 108A). Additionally, or alternatively, a buyer mDL authentication request may include one or more desired data elements (e.g., one or more desired portions of credential data) associated with the buyer mDL, location data, user profile data, user account data, social media data, smart mobile wallet identification data, user device identification data, and/or the like associated with the particular buyer.

As shown by operation 504, the apparatus 200 may include means, such as processor 202, memory 204, communications hardware 206, authentication circuitry 210, mDL management circuitry 212, and/or the like for generating a buyer digital token. In some embodiments, the authentication circuitry 210 may be configured to generate a buyer digital token comprising cryptographic information (e.g., public key information) associated with the buyer mDL of the buyer. Additionally, in some examples, the cryptographic information associated with the buyer mDL and comprised in the buyer digital token may be user device identification data by which the buyer device (e.g., buyer device 108A) of the buyer may be uniquely identified.

As shown by operation 506, the apparatus 200 may include means, such as processor 202, memory 204, communications hardware 206, and/or the like for transmitting the buyer digital token to an IA system. Once the buyer digital token is generated, the communications hardware 206 may provide the buyer digital token to an associated IA system. The communications hardware 206 may be configured to provide the buyer digital token to the IA system (e.g., IA system 110A) associated with the IA that provisioned the buyer mDL to the buyer such that the IA system (e.g., IA system 110A) may decrypt the cryptographic information comprised in the buyer digital token. In this manner, the IA system (e.g., IA system 110A) may authenticate (e.g., verify) one or more portions of credential data associated with the buyer mDL and/or one or more portions of user device identification data associated with the buyer device (e.g., buyer device 108A) of the buyer.

As shown by operation 508, the apparatus 200 may include means, such as processor 202, memory 204, communications hardware 206, and/or the like for receiving a buyer mDL validity response. The communications hardware 206 may be configured to receive a buyer mDL validity response from the IA system (e.g., IA system 110A) to which it provided the buyer digital token. In some embodiments, the buyer mDL validity response is generated by the IA system (e.g., IA system 110A) based on the buyer digital token. The buyer mDL validity response may be whether credential data (e.g., desired credential data) associated with the buyer mDL indicated by the buyer mDL authentication request was verified by the IA system. Furthermore, in some examples, the buyer mDL validity response may also indicate whether user device identification data related to the buyer device associated with the buyer (e.g., buyer device 108A) was verified by the IA system.

As shown by operation 510, the apparatus 200 may include means, such as processor 202, memory 204, authentication circuitry 210, and/or the like for authenticating the buyer based on the buyer mDL validity response. The authentication circuitry 210 may be configured to authenticate the buyer based on the data comprised in the buyer mDL validity response received from the IA system. Thus, the authentication circuitry 210 may be configured to determine whether the buyer has been successfully authenticated based on the buyer mDL validity response received. In some embodiments, the authentication circuitry 210 may successfully authenticate the buyer if the buyer mDL validity response is indicative that the credential data was verified. In some embodiments, the authentication circuitry 210 may successfully authenticate the buyer if the buyer mDL validity response is indicative that the credential data was verified and the user device identification data was verified. In some embodiments, if the authentication circuitry 210 determines that the buyer mDL validity response is indicative that the IA system failed to verify certain credential data and/or user device identification data, the authentication circuitry 210 may fail to authenticate the buyer.

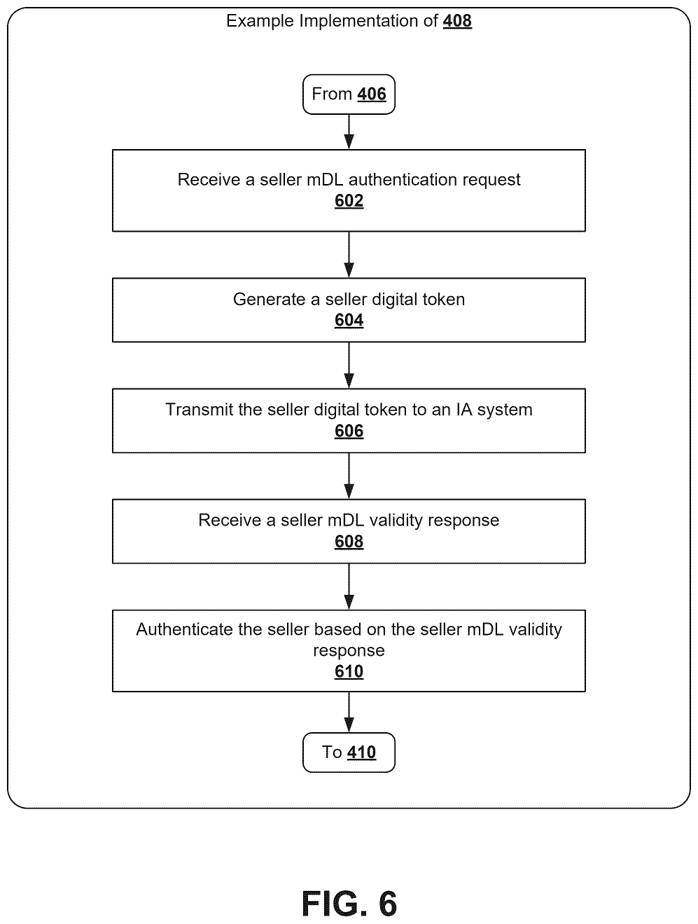

Returning now to FIG. 4, as shown by operation 408, the apparatus 200 may include means, such as processor 202, memory 204, communications hardware 206, authentication circuitry 210, mDL management circuitry 212, smart mobile wallet management circuitry 214, and/or the like for authenticating a seller based on a seller mDL. As described above, in some embodiments, the communications hardware 206 may be configured to receive a seller mDL authentication request. In some embodiments, the seller mDL authentication request may be received from a seller device (e.g., seller device 106A). In some embodiments, the seller mDL authentication request is included in the transfer message. Alternatively, in some embodiments, seller mDL authentication request is received in a separate communication from the transfer message. If the seller mDL authentication request is received in a separate communication, the seller mDL authentication request may include a transfer message identifier. As such, the authentication circuitry 210 may be configured to identify the corresponding transfer request to which the seller mDL authentication request pertains. In some embodiments, the authentication circuitry 210 may successfully authenticate the seller in an instance in which the seller is successfully verified based on a seller mDL validity response, as described in FIG. 6.

In some embodiments, operation 408 may be performed in accordance with the operations described by FIG. 6. Turning now to FIG. 6, example operations are shown for authenticating a seller based on a seller mDL authentication request.

As shown by operation 602, the apparatus 200 may include means, such as processor 202, memory 204, communications hardware 206, and/or the like for receiving a seller mDL authentication request. The seller mDL authentication request may be a request to authenticate a seller mDL associated with the seller and thereby authenticate the identity of the seller for the P2P exchange. As described above, the seller mDL authentication request may include one or more of cryptographic information (e.g., public key information) associated with a seller mDL and/or a seller device (e.g., seller device 106A). Additionally, or alternatively, a seller mDL authentication request may include one or more desired data elements (e.g., one or more desired portions of credential data) associated with the seller mDL, location data, user profile data, user account data, social media data, smart mobile wallet identification data, user device identification data, and/or the like associated with the particular seller.

As shown by operation 604, the apparatus 200 may include means, such as processor 202, memory 204, communications hardware 206, authentication circuitry 210, mDL management circuitry 212, and/or the like for generating a seller digital token. In some embodiments, the authentication circuitry 210 may be configured to generate a seller digital token comprising cryptographic information (e.g., public key information) associated with the seller mDL of the seller. Additionally, in some examples, the cryptographic information associated with the seller mDL and comprised in the seller digital token may be user device identification data by which the seller device (e.g., seller device 106A) of the seller may be uniquely identified.

As shown by operation 606, the apparatus 200 may include means, such as processor 202, memory 204, communications hardware 206, and/or the like for transmitting the seller digital token to an IA system. Once the seller digital token is generated, the communications hardware 206 may provide the seller digital token to an associated IA system. The communications hardware 206 may be configured to provide the seller digital token to the IA system (e.g., IA system 110A) associated with the IA that provisioned the seller mDL to the seller such that the IA system (e.g., IA system 110A) may decrypt the cryptographic information comprised in the seller digital token. In this manner, the IA system (e.g., IA system 110A) may authenticate (e.g., verify) one or more portions of credential data associated with the seller mDL and/or one or more portions of user device identification data associated with the seller device (e.g., seller device 106A) of the seller.

As shown by operation 608, the apparatus 200 may include means, such as processor 202, memory 204, communications hardware 206, and/or the like for receiving a seller mDL validity response. The communications hardware 206 may be configured to receive a seller mDL validity response from the IA system (e.g., IA system 110A) to which it provided the seller digital token. In some embodiments, the seller mDL validity response is generated by the IA system (e.g., IA system 110A) based on the seller digital token. The seller mDL validity response may be whether credential data (e.g., desired credential data) associated with the seller mDL indicated by the seller mDL authentication request was verified by the IA system. Furthermore, in some examples, the seller mDL validity response may also indicate whether user device identification data related to the seller device associated with the seller (e.g., seller device 106A) was verified by the IA system.

As shown by operation 610, the apparatus 200 may include means, such as processor 202, memory 204, authentication circuitry 210, and/or the like for authenticating the seller based on the seller mDL validity response. The authentication circuitry 210 may be configured to authenticate the seller based on the data comprised in the seller mDL validity response received from the IA system. Thus, the authentication circuitry 210 may be configured to determine whether the seller has been successfully authenticated based on the seller mDL validity response received. In some embodiments, the authentication circuitry 210 may successfully authenticate the seller if the seller mDL validity response is indicative that the credential data was verified. In some embodiments, the authentication circuitry 210 may successfully authenticate the seller if the seller mDL validity response is indicative that the credential data was verified and the user device identification data was verified. In some embodiments, if the authentication circuitry 210 determines that the seller mDL validity response is indicative that the IA system failed to verify certain credential data and/or user device identification data, the authentication circuitry 210 may fail to authenticate the seller.

Returning now to FIG. 4, optionally, as shown by operation 410, the apparatus 200 may include means, such as processor 202, memory 204, communications hardware 206, item authentication circuitry 216, and/or the like for determining an inferred authenticity category for the item. In some embodiments, one or more of the items involved P2P exchange may have been previously purchased by the seller. Thus, the seller may provide historical transaction parameters that pertain to when the seller purchased the item and these historical transaction parameters may be used to determine the inferred authenticity category. An inferred authenticity category may be indicative of an inferred likelihood that an item in the P2P exchange is authentic. For example, an inferred authenticity category may include a “very likely authentic” category, a “likely authentic” category, a “neutral authentic” category, an “unlikely authentic” category, or a “very unlikely authentic” category. As such, the inferred authenticity category may provide the buyer with a metric of confidence that a corresponding item is authentic and may further aid the buyer in avoiding a would-be scam.

As described above, in some embodiments, the transfer message may be indicative of a request to determine an inferred authenticity category for the item involved in the exchange. The item authentication circuitry 216 may determine an inferred authenticity category for the item based on one or more historical transaction parameters provided by the seller. In some embodiments, the one or more historical transaction parameters may be provided in the transfer message. Additionally, or alternatively, the one or more historical transaction parameters may be provided in a separate communication between communications hardware 206 and the seller device (e.g., seller device 106A). The one or more historical transaction parameters may be provided by the seller and may pertain to an item involved in the P2P exchange. These historical transaction parameters may be indicative of an original transaction price for the one or more items, a merchant identifier, a transaction number, a transaction date, a seller account used for the transaction, and/or the like.

In some embodiments, the historical transaction parameters may be directly provided by a seller via user input. For example, the seller may manually provide this information in the transfer message via seller device (e.g., seller device 106A). In some embodiments, the one or more historical transaction parameters may be provided via an attachment, link, or other reference. For example, the seller may upload a picture or copy of an associated physical receipt or digital receipt for a transaction during which the item was purchased. As another example, the seller may include an exchange transfer record identifier for a previous P2P exchange during which the seller received the item. In some embodiments, the item authentication circuitry 216 may process these attachments, links, references and/or the like to identify the one or more historical transaction parameters using any suitable technique, such as optical character recognition (OCR), natural language processing (NLP) techniques and/or models, keyword identification, and/or the like.

In some embodiments, operation 410 may be performed in accordance with the operations described by FIG. 7. Turning now to FIG. 7, example operations are shown for determining an inferred authenticity category for an item based on a transaction match likelihood score.

As shown by operation 702, the apparatus 200 may include means, such as processor 202, memory 204, item authentication circuitry 216, and/or the like for identifying a candidate historical transaction within a seller account. In some embodiments, the item authentication circuitry 216 may identify a candidate historical transaction within an associated seller account of a seller profile. As described above, a user profile of a seller may include one or more seller accounts and a seller account may be associated with a payment account (e.g., credit account, checking account, savings account, investment account). As such, the item authentication circuitry 216 may filter seller accounts to include only payment accounts and further, may select a seller account based on the historical transaction parameters. In particular, the one or more historical transaction parameters may be indicative of a seller account used to facilitate the historical transaction. The item authentication circuitry 216 may further identify a candidate historical transaction within the selected seller account.

In some embodiments, the item authentication circuitry 216 may identify a candidate historical transaction based on temporal data indicated by the one or more historical transaction parameters provided by the seller. For example, the item authentication circuitry 216 may determine a historical transaction parameter is indicative that the corresponding transaction occurred on Jun. 1, 2024. As such, the item authentication circuitry 216 may identify one or more candidate historical transactions within the seller account which occurred on Jun. 1, 2024. The item authentication circuitry 216 may further use a provided timestamp of the transaction to identify a candidate historical transaction in an instance in which multiple transactions occurred on the particular date. Alternatively, each transaction that occurred on the given date may be identified as a candidate transaction and a transaction match likelihood score may be generated for each. In this way, the item authentication circuitry 216 may intelligently filter out irrelevant transactions which cannot match the provided historical transaction parameters, thereby conserving computational bandwidth.

As shown by operation 704, the apparatus 200 may include means, such as processor 202, memory 204, item authentication circuitry 216, and/or the like for generating a transaction match likelihood score. Once the item authentication circuitry 216 has identified a candidate historical transaction, the item authentication circuitry 216 may generate a transaction match likelihood score for the candidate historical transaction. The transaction match likelihood score may be indicative of a likelihood or probability that candidate historical transaction corresponds to a transaction during which the seller purchased the item. In an instance in which the item authentication circuitry 216 has identified more than one candidate historical transaction, the item authentication circuitry 216 may generate a transaction match likelihood score for each candidate historical transaction.

In some embodiments, the item authentication circuitry 216 may use an authenticity category machine learning model to generate the transaction match likelihood score. In some embodiments, the authenticity category machine learning model is a machine learning model that is trained to compare values of historical transaction parameters to corresponding values of candidate historical transaction parameters to generate a transaction match likelihood score. In some embodiments, the authenticity category machine learning model may be configured to use comparison techniques such as a cosine similarity, Euclidean distance, Manhattan distance, Jaccard similarity, Pearson correlation, Hamming distance, and/or the like. The authenticity category machine learning model may perform this comparison for each provided historical transaction parameter and/or candidate historical transaction parameter and may generate the transaction match likelihood score based on the comparison between the various parameters. In some embodiments, a higher the degree of similarity between the historical transaction parameters and/or candidate historical transaction parameters will result in a more likely transaction match likelihood score.

The authenticity category machine learning model may be trained using supervised learning techniques. For example, the authenticity category machine learning model may be trained using training historical transaction parameters of a training transaction and training candidate historical transaction parameters of a training candidate transaction. The training candidate historical transaction and/or training historical transaction may be labelled with an indication of whether the two transactions match. As such, the authenticity category machine learning model may be configured to infer the degree in which transaction parameters between two transactions may vary and/or match.

In some embodiments, the transaction match likelihood score may be a numerical value within a scaled numerical range (e.g., between 0 and 1, between 0 and 100, and/or the like). As described above, the transaction match likelihood score may be indicative of a likelihood or probability that candidate historical transaction corresponds to a transaction during which the seller purchased the item. For example, a transaction likelihood score of 0 may be indicative that the candidate historical transaction is definitively not the transaction during which the seller purchased the item. As another example, a transaction likelihood score of 100 may be indicative that the candidate historical transaction is definitively the transaction during which the seller purchased the item.

As shown by operation 706, the apparatus 200 may include means, such as processor 202, memory 204, item authentication circuitry 216, and/or the like for determining the inferred authenticity category based on the transaction match likelihood score. Once a transaction match likelihood score has been generated for one or more candidate historical transactions, the item authentication circuitry 216 may determine an inferred authenticity category for the item. In particular, the item authentication circuitry 216 may determine whether the transaction match likelihood score satisfies one or more thresholds to determine the inferred authenticity category. For example, the item authentication circuitry 216 may be configured to determine a “very unlikely authentic” category in an instance in which the transaction match likelihood score is less than a threshold value of 20. As another example, the item authentication circuitry 216 may be configured to determine an “unlikely authentic” category in an instance in which the transaction match likelihood score is greater than or equal to a threshold value of 20 but less than a threshold value of 40. As another example, the item authentication circuitry 216 may be configured to determine a “neutral authentic” category in an instance in which the transaction match likelihood score is greater than or equal to a threshold value of 40 but less than a threshold value of 60. As another example, the item authentication circuitry 216 may be configured to determine a “likely authentic” category in an instance in which the transaction match likelihood score is greater than or equal to a threshold value of 60 but less than a threshold value of 80. As yet another example, the item authentication circuitry 216 may be configured to determine a “very likely authentic” category in an instance in which the transaction match likelihood score is greater than or equal to a threshold value of 80.

In some embodiments, in an instance in which the item authentication circuitry 216 determined a transaction match likelihood score for multiple candidate historical transactions, the item authentication circuitry 216 may be configured to select a single transaction match likelihood score. In some embodiments, the item authentication circuitry 216 may be configured to select the transaction match likelihood score that is indicative of the highest likelihood that the candidate historical transaction corresponds to the transaction during which the seller purchased the item. For example, the item authentication circuitry 216 may have determined a transaction match likelihood score of 58 for a first candidate historical transaction and a transaction match likelihood score of 82 for a second candidate historical transaction. As such, the item authentication circuitry 216 may be configured to select the transaction match likelihood score of 82 for the second candidate historical transaction when determining the inferred authenticity category for the item.

Additionally, or alternatively, in some embodiments, operation 410 may be performed in accordance with the operations described by FIG. 8. Turning now to FIG. 8, example operations are shown for determining an inferred authenticity category for an item based on whether a merchant is successfully verified.

As shown by operation 802, the apparatus 200 may include means, such as processor 202, memory 204, item authentication circuitry 216, and/or the like for verifying whether a merchant identifier is associated with an item type corresponding to the item. In some embodiments, the item authentication circuitry 216 may identify a merchant identifier from the one or more historical transaction parameters. A merchant identifier may uniquely identify a merchant associated with the corresponding historical transaction. In some embodiments, the item authentication circuitry 216 may be configured to determine whether the merchant identifier is a verified merchant for the particular item type of the item in the P2P exchange. By way of particular example, a merchant identifier for a P2P exchange involving concert ticket items may be verified in order to ensure the merchant is a legitimate and authentic merchant for concert tickets. As such, the item authentication circuitry 216 may verify the merchant identifier to ensure the item came from an authorized retailer, thereby decreasing the likelihood that the item in the P2P transaction is a fake or inauthentic item. This may be particularly useful in instances in which the historical transaction parameters are provided directly by the seller as opposed to from a receipt or other documentation.

In some embodiments, the item authentication circuitry 216 may be configured to determine an item type for an item in the transfer message. In some embodiments, the transfer message may include an item type for the item such that the item authentication circuitry 216 may determine the item type directly from the transfer message. In some embodiments, the item authentication circuitry 216 may be configured to determine an item type based on a keywords included in the item description or name included in the transfer message. In some embodiments, the item authentication circuitry 216 may be configured to use an item type categorization model. In some embodiments, the item type categorization model may be a rules-based or machine learning model that is configured to receive the item description or name of the item and/or one or more other historical transaction parameters and determine an item type for the item. In some embodiments, the item type categorization model may be configured to use any suitable technique, such as NLP processing, keyword analysis, and/or one or more the like to determine an item type. In some embodiments, the item type categorization model may be configured to use a web crawler or other query to identify digitally available information for a particular item name and may also use this information to determine an item type.

The item authentication circuitry 216 may further determine whether a merchant identifier is associated with the item type. In some embodiments, the item authentication circuitry 216 may be configured with a verified merchant list. The verified merchant list may include merchant identifiers and one or more corresponding item types known to be offered by the associated merchant. In some embodiments, the verified merchant list may be curated and/or maintained manually. In some embodiments, the verified merchant list may be curated and/or maintained using a web crawler or other digital tool that may be configured to browse verified merchant websites to determine item types offered by the merchant. In some embodiments, a new item type offered by a merchant identifier may first be required to be manually verified by a trusted user (e.g., a user affiliated with apparatus 200) prior to the item type being added to the verified merchant list. The item authentication circuitry 216 may look-up the merchant identifier within the verified merchant list and determine whether the determined item type is listed as associated with the merchant. In an instance in which the item type is associated with the merchant identifier, the item authentication circuitry 216 may successfully verify the merchant identifier. In an instance in which the item type is not associated with the merchant identifier, the item authentication circuitry 216 may fail to verify the merchant identifier.

As shown by operation 804, the apparatus 200 may include means, such as processor 202, memory 204, item authentication circuitry 216, and/or the like for determining the inferred authenticity category based on whether the merchant identifier was successfully verified. Once the item authentication circuitry 216 has either successfully verified the merchant identifier or failed to verify the merchant identifier, the item authentication circuitry 216 may determine the inferred authenticity category for the item based on the merchant identifier verification. In some embodiments, in an instance in which the merchant identifier failed to be verified, the item authentication circuitry 216 may determine a “very unlikely authentic” category or a “unlikely authentic” category for the inferred authenticity category. In some embodiments, in an instance in which the merchant identifier was successfully verified, the item authentication circuitry 216 may determine a “very likely authentic” category or a “likely authentic” category for the inferred authenticity category.

In some embodiments, in an instance in which the merchant identifier is verified and a transaction match likelihood score is determined, the item authentication circuitry 216 may consider both factors to determine an inferred authenticity category for the item. In some embodiments, the item authentication circuitry 216 may be configured with an authenticity category rule set that includes one or more rules to determine an inferred authenticity category based on whether the merchant identifier is successfully verified and the transaction match likelihood score. For example, in some embodiments, in an instance in which the merchant identifier was successfully verified but a transaction match likelihood score was not determined, the item authentication circuitry 216 may determine a “likely authentic” category for the inferred authenticity category. Additionally, in an instance in which the transaction match likelihood score was 72, the item authentication circuitry 216 may be configured to determine a “likely authentic” category for the inferred authenticity category. However, in an instance in which the which the merchant identifier was successfully verified and a transaction match likelihood score of 72 was determined, the authenticity category rule set may be indicative determine a “very likely authentic” category for the inferred authenticity category.

Returning now to FIG. 4, as shown by operation 412, the apparatus 200 may include means, such as processor 202, memory 204, communications hardware 206, exchange management circuitry 208, and/or the like for updating the exchange transfer record. Once the exchange management circuitry 208 has determined one of more changes and/or updates, the exchange management circuitry 208 may update the exchange transfer record to reflect these updates. In particular, the exchange management circuitry 208 may update the authentication status for the buyer based on the authentication of the buyer as described in operation 406. For example, in an instance in which the buyer was successfully authenticate, the exchange management circuitry 208 may update the authentications status of the buyer to “authenticated.” As another example, in an instance in which the buyer failed to be authenticate, the exchange management circuitry 208 may update the authentications status of the buyer to “could not be authenticated.” The exchange management circuitry 208 may also update the authentication status for the seller based on the authentication of the seller as described in operation 408. For example, in an instance in which the seller was successfully authenticate, the exchange management circuitry 208 may update the authentications status of the seller to “authenticated.” As another example, in an instance in which the seller failed to be authenticate, the exchange management circuitry 208 may update the authentications status of the seller to “could not be authenticated.” As such, the exchange management circuitry 208 may update the exchange transfer record to reflect the current and up-to-date authentication status of the buyer and seller.

In some embodiments, the exchange management circuitry 208 may also update the exchange transfer record to reflect an inferred authenticity category for one or more items. For example, for each item an inferred authenticity category was determined for, the exchange management circuitry 208 may update the exchange transfer record to include a current and up-to-date inferred authenticity category. By way of continuing example, if an inferred authenticity category was determined for a first concert ticket and a second concert ticket, the exchange management circuitry 208 may update an inferred authenticity category value within the exchange transfer record to reflect the determined inferred authenticity category for both the first concert ticket and the second concert ticket.

In some embodiments, the exchange management circuitry 208 may further generate an item exchange recommendation for the buyer and/or seller based on the current information in the exchange transfer record. In some embodiments, the exchange management circuitry 208 may be configured to generate an item exchange recommendation using a recommendation model. A recommendation model may be a rules-based or machine learning model that is configured to process the values for one or more fields of the exchange transfer record to generate an item exchange recommendation. In particular, in some embodiments, the recommendation model may process a value for an authentication status of a buyer, an authentication status for a seller, and/or an inferred authenticity category for the one or more items involved in the P2P exchange to generate an item exchange recommendation. In some embodiments, the recommendation model may be a tree-based model or other rules-based model that is configured to process the one or more values for particular fields in the exchange transfer record. For example, if a buyer or seller has not yet been successfully authenticated, the item exchange recommendation for the exchange may be indicative to hold off on the exchange until the party has been successfully authenticated. As another example, if both the buyer and seller have been successfully authenticated, the item exchange recommendation for the exchange may be indicative that it is now safe to perform the exchange. As yet another example, if a buyer or seller fails to be successfully authenticated, the item exchange recommendation for the exchange may be indicative to not complete the exchange and may flag the party as a potential fraudster.

It will be appreciated that the exchange management circuitry 208 may update the exchange transfer record in real-time or substantially real-time. For example, the exchange management circuitry 208 may update an authentication status for a seller as soon as the authentication status for the seller is determined and/or is modified. As such, operation 412 may occur after each of operations 406, 408, and/or 410. Furthermore, in some embodiments, operations 406, 408, and 410 may be performed simultaneously, such as via parallel processing. This may allow for fast and accurate provision of the exchange transfer record to the buyer and/or seller such that the parties may make determination regarding the P2P exchange based on real-time updates and thus, avoid lengthy delays.

As shown by operation 414, the apparatus 200 may include means, such as processor 202, memory 204, communications hardware 206, and/or the like for providing the exchange transfer record. Once the exchange management circuitry 208 has updated the exchange transfer record, the communications hardware 206 may provide the exchange transfer record. In some embodiments, the communications hardware 206 provides the exchange transfer record to the device which provided the transfer message (e.g., the buyer device 108A or the seller device 106A). In some embodiments, the communications hardware 206 provides the exchange transfer record to both the buyer device (e.g., buyer device 108A) and the seller device (e.g., seller device 106A). In some embodiments, the transfer message may be indicative of a device identifier for both the buyer device and seller device such that communications hardware 206 may use this information to provide the exchange transfer record to both devices. In some embodiments, the communications hardware 206 may provide the exchange transfer record after each update such that the parties are made aware of real-time updates.

In some embodiments, the communications hardware 206 may provide the exchange transfer record to the exchange transfer record repository 120. The exchange transfer record repository 120 may be configured to store and maintain exchange transfer records for a predetermined period of time (e.g., 5 years). In some embodiments, the exchange transfer record may be linked to the buyer profile and/or seller profile such that it may be viewable to the buyer and/or seller within a corresponding user profile. For example, a buyer and/or seller may use an associated software application via a buyer device and/or seller device, respectively, to view the exchange transfer record within his/her user profile. As such, the communications hardware 206 may store, update, and maintain the exchange transfer record within the exchange transfer record repository 120 and the buyer and/or seller may use an associated software application to view the exchange transfer record.

In some embodiments, the exchange transfer record may be associated with a change log, which may also be stored in the exchange transfer record repository 120. The change log may track and log each update made to the exchange transfer record as well as temporal information (e.g., a date, a timestamp, or the like) or other information pertaining to when the change was made. In some embodiments, the change log may further include relevant events pertaining to the exchange transfer record. For example, the change log may include a transfer message event as described in operation 402, authentication events performed for the buyer as described in operation 406, authentication events performed for the seller as described in operation 408, an exchange confirmation message event as described in operation 416, an effectuation of funds event as described in operation 418, and/or the like. These events may include temporal data, location data, and/or the like.

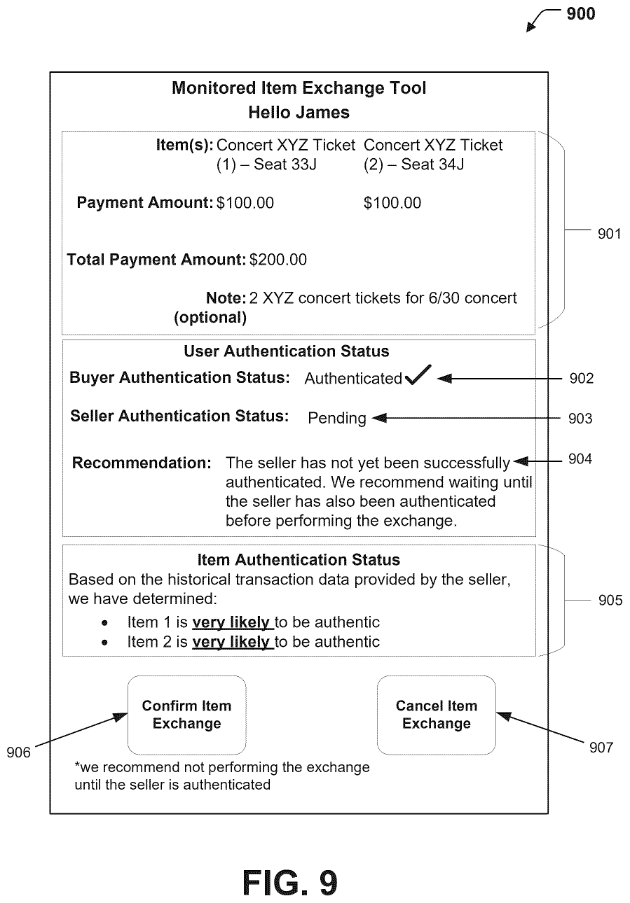

As illustrated in FIG. 9, an example user interface 900 may include one or more interactive user interface elements (e.g., interactive user interface elements 906-907) and a digital representation of the exchange transfer record. The exchange transfer record may include an indication of the P2P exchange details 901, as received in the transfer message. Additionally, the exchange transfer record may include values for a buyer authentication status 902 and a seller authentication status 903. Additionally, the exchange transfer record may include an item exchange recommendation 904. Furthermore, the exchange transfer record may include an inferred authenticity category for the items involved in P2P exchange 905.

In some embodiments, a user may interact with user interface element 906 to cause an exchange confirmation message to be received by communications hardware 206. In some embodiments, a user may interact with user interface element 907 to cancel the P2P item exchange. In some embodiments, a cancelled P2P item exchange may cause the exchange management circuitry 208 to delete the exchange transfer record from the exchange transfer record repository. Alternatively, a cancelled P2P item exchange may cause the exchange management circuitry 208 to update an exchange confirmation status to indicate the cancellation. In various examples, the one or more interactive user interface elements 906-907 may be configured as interactive buttons that may be utilized to initiate various commands (e.g., executable software instructions) based one or more interactions (e.g., selections, indications, manipulations) with the interactive user interface elements.

As shown by operation 416, the apparatus 200 may include means, such as processor 202, memory 204, communications hardware 206, and/or the like for receiving an exchange confirmation message. The exchange confirmation message may be indicative that the seller has provided the buyer with the one or more items for the P2P exchange. In some embodiments, the communications hardware 206 may receive the exchange confirmation message from the seller device (e.g., seller device 106A). Additionally, or alternatively, the communications hardware 206 may receive the exchange confirmation message from the buyer device (e.g., buyer device 108A). The exchange confirmation message may be received via a software application. In some embodiments, regardless of the device which provides the exchange confirmation message to the communications hardware 206, the exchange confirmation message may have been generated based on input from both the seller device (e.g., seller device 106A) and the buyer device (e.g., buyer device 108A). In some embodiments, the exchange confirmation message may be received by communications hardware 206 in an instance in which both the buyer device (e.g., buyer device 108A) and seller device (e.g., seller device 106A) have received user input indicative that the corresponding user has confirmed the buyer has received the one or more items from the seller.

Optionally, as shown by operation 418, the apparatus 200 may include means, such as processor 202, memory 204, communications hardware 206, exchange management circuitry 208, and/or the like for effectuating a transfer of funds. The transfer message may pertain to a P2P exchange for a predetermined amount of funds. In some embodiments, the transfer message may further include an indication of a request for apparatus 200 to effectuate the transfer of funds. As such, in some embodiments, the exchange management circuitry 208 may effectuate the transfer of funds from a buyer account to a seller account upon receipt of an exchange confirmation message. As such, once the exchange confirmation message indicative that the items have been provided from the seller to the buyer, the exchange management circuitry 208 may further effectuate the transfer of funds. This ensures that the seller receives the predetermined amount funds from the buyer.

In some embodiments, the transfer message and/or exchange confirmation message may further include an indication of a buyer account to which funds should be transferred. In some embodiments, the transfer message and/or exchange confirmation message may further include an indication of a seller account from which the predetermined amount of funds should be transferred from. Alternatively, in some embodiments, the exchange management circuitry 208 may select a buyer account and/or seller account. For example, the exchange management circuitry 208 may identify that user preferences in the buyer or seller user profile that are indicative of a particular account to be used for P2P exchanges. As such, the exchange management circuitry 208 may automatically select a buyer account and/or seller account to be used for transfer of funds.

In some embodiments, the method of transfer of the funds may be dependent upon user preferences in the buyer profile and/or user preferences in the seller profile. For example, the buyer profile may include user preferences indicative of one or more preferred payment rails for providing monetary funds and the seller profile may also include user preferences indicative of one or more preferred payment rails for receiving monetary funds. In some embodiments, the exchange management circuitry 208 may consider only the seller preferences and effectuate the transfer of funds in accordance with the seller transfer preferences. In some embodiments, the exchange management circuitry 208 may consider only the buyer preferences and effectuate the transfer of funds in accordance with the buyer's transfer preferences. In some embodiments, the exchange management circuitry 208 may consider both the buyer preferences and seller preferences and may effectuate a transfer of funds in accordance with a preference indicated in both the buyer profile and seller profile. As such, the exchange management circuitry 208 may effectuate the transfer of funds from the buyer's account to the seller's account using the selected transfer method. By way of continuing example, in an instance in which a confirmation message is received, the exchange management circuitry 208 may effectuate the transfer of $200 funds from the buyer's account to the seller's account for the 2 concert tickets.

In some embodiments, in an instance in which the transfer message includes an indication of a request to effectuate a transfer of funds, the exchange management circuitry 208 may be configured to verify that an associated seller account has sufficient funds to satisfy the predetermined amount of funds prior to receiving the exchange confirmation message. As such, the seller may be made aware if the buyer has insufficient funds for the P2P exchange prior to providing the buyer with the items. In some embodiments, the exchange management circuitry 208 may still effectuate the transfer of funds from a seller account even in an instance in which the seller account has insufficient funds.

As shown by operation 420, the apparatus 200 may include means, such as processor 202, memory 204, communications hardware 206, exchange management circuitry 208, and/or the like for updating the exchange transfer record. Once the exchange confirmation message has been received as described in operation 416, the exchange management circuitry 208 may update the exchange transfer record to reflect that the P2P exchange has been completed. In some embodiments, the exchange management circuitry 208 may update the exchange confirmation status field to a value to indicate the P2P exchange has occurred. Additionally, the exchange management circuitry 208 may update a value for an exchange confirmation date field and/or exchange confirmation location field in the exchange transfer record based on the confirmation message. As such, the status of the P2P exchange and pertinent details (e.g., temporal and location information) may be known and updated in the exchange transfer record such that the exchange transfer record may serve as a reliable source for P2P exchanges. The exchange management circuitry 208 may update the stored exchange transfer record, which may be stored in exchange transfer record repository 120. As such, the stored exchange transfer record may be accurate and up to date.

As discussed above, the transfer message and/or exchange confirmation message may be received in an instance in which the buyer and seller have provided feedback indicative of authorization to do so. Additionally, the exchange transfer record may include pertinent details as provided and agreed upon by the buyer and seller as well as information as determined by apparatus 200 (e.g., an authentication status for the buyer, an authentication status for the seller, an item exchange recommendation, an inferred authenticity category for one or more items, whether an effectuation of a transfer of funds was performed, and/or the like. Additionally, the transfer message may be associated with a change log. In an instance in which a buyer and/or a seller reports an issue with a P2P exchange, an authorized user (e.g., an employee affiliated with an organization that operates apparatus 200) may view the exchange transfer record and/or change log to settle the dispute.

FIGS. 4-9 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable enhanced P2P exchanges. Example embodiments thus provide tools that overcome the problems faced by conventional P2P exchanges mechanisms and techniques. By avoiding the use of conventional P2P exchange mechanisms and techniques, example embodiments thus save time and resources, while also reducing the likelihood of a party being scammed. Moreover, embodiments described herein counter a wide variety of emerging risks in an evolving technological landscape.

Example embodiments contemplated herein provide technical solutions that solve real-world problems faced by users who wish to safely and securely perform P2P exchanges by employing various mDL-based user authentication techniques. And while confirming the identity of an individual has been a technical challenge for years, the increasing number of self-employed individuals using online-based marketing tools, online classifieds, and/or service aggregation websites has made this problem significantly more acute, especially as identity fraud and impersonation techniques become more sophisticated. By utilizing a legally issued mDL to authenticate a buyer and/or seller, embodiments of the present disclosure ensure that both the buyer and seller are properly verified prior to the P2P exchange occurring, thereby increasing the security and safety for both parties.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for enhancing security of a peer-to-peer item exchange, the method comprising:
receiving, by communications hardware, a transfer message, wherein the transfer message comprises (a) an indication of an item to be exchanged, (b) an indication of a buyer, and (c) an indication of a seller;
generating, by exchange management circuitry, an exchange transfer record, wherein the exchange transfer record comprises (a) the indication of the item, (b) an authentication status for the buyer, and (c) an authentication status for the seller;
authenticating, by authentication circuitry, the buyer based on a buyer mobile driver's license (mDL) associated with the buyer;
authenticating, by the authentication circuitry, the seller based on a seller mDL associated with the seller;
updating, by the exchange management circuitry, the exchange transfer record based on the authentication status of the buyer and the authentication status of the seller; and
providing, by the communications hardware, the exchange transfer record.

2. The method of claim 1, wherein the method further comprises:
determining, by item authentication circuitry and based on one or more historical transaction parameters associated with the item, an inferred authenticity category for the item; and
updating, by the exchange management circuitry, the exchange transfer record based on the inferred authenticity category.

3. The method of claim 2, further comprising:
identifying, by the item authentication circuitry and based on the one or more historical transaction parameters, a candidate historical transaction within a seller account associated with the seller, wherein the candidate historical transaction is associated with one or more candidate historical transaction parameters; and
generating, by the item authentication circuitry and based on the one or more historical transaction parameters and the one or more candidate historical transaction parameters, a transaction match likelihood score, wherein the inferred authenticity category is determined based on the transaction match likelihood score.

4. The method of claim 2, further comprising verifying, by the item authentication circuitry, whether a merchant identifier indicated by the one or more historical transaction parameters is associated with an item type corresponding to the item, wherein the inferred authenticity category is determined based on whether the merchant identifier is successfully verified.

5. The method of claim 1, further comprising:
receiving, by the communications hardware, an exchange confirmation message, wherein the exchange confirmation message is indicative that an exchange involving the item has occurred; and
updating, by the exchange management circuitry, the exchange transfer record based on the exchange confirmation message.

6. The method of claim 5, further comprising in response to receiving the exchange confirmation message, effectuating, by the exchange management circuitry, a transfer of funds from a buyer account to a seller account.

7. The method of claim 1, wherein authenticating the buyer further comprises:
receiving, by the communications hardware, a buyer mDL authentication request, wherein the buyer mDL authentication request is a request to authenticate the buyer mDL associated with the buyer;
generating, by the authentication circuitry and based on the buyer mDL authentication request, a buyer digital token;
transmitting, by the communications hardware, the buyer digital token to an issuing authority (IA) system associated with an IA that provisioned the buyer mDL to the buyer;
receiving, by the communications hardware and from the IA system, a buyer mDL validity response, wherein the buyer mDL validity response is generated based on the buyer digital token, and wherein the buyer mDL validity response indicates verified credential data associated with the buyer mDL; and
authenticating, by the authentication circuitry, the buyer based on the buyer mDL validity response.

8. The method of claim 7, wherein the buyer mDL authentication request comprises one or more of buyer identification data, desired credential data associated with the buyer mDL, or user attribute data associated with the buyer.

9. The method of claim 8, wherein the buyer mDL validity response further indicates verified buyer device identification data related to a buyer device.

10. The method of claim 1, wherein authenticating the seller further comprises:
receiving, by the communications hardware, a seller mDL authentication request, wherein the seller mDL authentication request is a request to authenticate the seller mDL associated with the seller;
generating, by the authentication circuitry and based on the seller mDL authentication request, a seller digital token;
transmitting, by the communications hardware, the seller digital token to an issuing authority (IA) system associated with an IA that provisioned the seller mDL to the seller;
receiving, by the communications hardware and from the IA system, a seller mDL validity response, wherein the seller mDL validity response is generated based on the seller digital token, and wherein the seller mDL validity response indicates verified credential data associated with the seller mDL; and
authenticating, by the authentication circuitry, the seller based on the seller mDL validity response.

11. The method of claim 10, wherein the seller mDL authentication request comprises one or more of seller identification data, desired credential data associated with the seller mDL, or user attribute data associated with the seller.

12. The method of claim 11, wherein the seller mDL validity response further indicates verified seller device identification data related to a seller device.

13. An apparatus for enhancing security of a peer-to-peer item exchange, the apparatus comprising:
communications hardware configured to receive a transfer message, wherein the transfer message comprises (a) an indication of an item to be exchanged, (b) an indication of a buyer, and (c) an indication of a seller;
exchange management circuitry configured to generate an exchange transfer record, wherein the exchange transfer record comprises (a) the indication of the item, (b) an authentication status for the buyer, and (c) an authentication status for the seller; and
authentication circuitry configured to:
authenticate the buyer based on a buyer mobile driver's license (mDL) associated with the buyer, and
authenticate the seller based on a seller mDL associated with the seller,
wherein the exchange management circuitry is further configured to update the exchange transfer record based on the authentication status of the buyer and the authentication status of the seller, and
wherein the communications hardware is further configured to provide the exchange transfer record.

14. The apparatus of claim 13, wherein the apparatus further comprises item authentication circuitry configured to determine, based on one or more historical transaction parameters associated with the item, an inferred authenticity category for the item, and
wherein the exchange management circuitry is further configured to update the exchange transfer record based on the inferred authenticity category.

15. The apparatus of claim 14, wherein the item authentication circuitry is further configured to:
identify, based on the one or more historical transaction parameters, a candidate historical transaction within a seller account associated with the seller, wherein the candidate historical transaction is associated with one or more candidate historical transaction parameters; and
generate, based on the one or more historical transaction parameters and the one or more candidate historical transaction parameters, a transaction match likelihood score, wherein the inferred authenticity category is determined based on the transaction match likelihood score.

16. The apparatus of claim 14, wherein the item authentication circuitry is further configured to verify whether a merchant identifier indicated by the one or more historical transaction parameters is associated with an item type corresponding to the item, wherein the inferred authenticity category is determined based on whether the merchant identifier is successfully verified.

17. The apparatus of claim 13, wherein the communications hardware is further configured to receive an exchange confirmation message, wherein the exchange confirmation message is indicative that an exchange involving the item has occurred, and
wherein the exchange management circuitry is further configured to update the exchange transfer record based on the exchange confirmation message.

18. The apparatus of claim 17, wherein the exchange management circuitry is further configured to effectuate a transfer of funds from a buyer account to a seller account.

19. A system for enhancing security of a peer-to-peer item exchange, the system comprising:
means for receiving a transfer message, wherein the transfer message comprises (a) an indication of an item to be exchanged, (b) an indication of a buyer, and (c) an indication of a seller;
means for generating an exchange transfer record, wherein the exchange transfer record comprises (a) the indication of the item, (b) an authentication status for the buyer, and (c) an authentication status for the seller;
means for authenticating the buyer based on a buyer mobile driver's license (mDL) associated with the buyer;
means for authenticating the seller based on a seller mDL associated with the seller;
means for updating the exchange transfer record based on the authentication status of the buyer and the authentication status of the seller; and
means for providing the exchange transfer record.

20. The system of claim 19, the system further comprising:
means for determining, based on one or more historical transaction parameters associated with the item, an inferred authenticity category for the item; and
means for updating the exchange transfer record based on the inferred authenticity category.
